(19) United States
(12) Patent Application Publication
(10) Pub. No.: US 2020/0202349 A1
(43) Pub. Date: Jun. 25, 2020

(54) MULTIPLE ASSET TRANSACTIONS

(71) Applicant: RIPPLE LABS INC., San Francisco, CA (US)

(72) Inventor: Nikolaos Dimitrios Bougalis, Las Vegas, NV (US)

(21) Appl. No.: 16/228,227

(22) Filed: Dec. 20, 2018

(51) Int. Cl. G06Q 20/40; H04L 9/06; H04L 9/14; H04L 9/08

(52) U.S. Cl. CPC G06Q 20/401; H04L 9/0637; H04L 2209/38; H04L 9/0825; G06Q 2220/10; H04L 9/14

(57) ABSTRACT

Systems and techniques are disclosed for the transfer of multiple assets between a first agent and a second agent using a decentralized transaction system via rotation of public key identifiers.

### FIELD OF THE DISCLOSURE

This disclosure relates to techniques for performing multiple electronic transfers of assets. In particular, this disclosure relates to techniques for achieving multiple asset transfers in a decentralized transaction system.

### BACKGROUND

A distributed or decentralized system for electronic transactions involving assets may include a decentralized structure for recording transactions such as a blockchain or ledger and a mechanism for establishing trust in transactions performed by users of the system. The latter is particularly important because a fundamental feature of a decentralized transaction system is the elimination of A centralized trusted entity such as a bank and/or a government to insure trust. For example, cryptocurrency technologies provide for the exchange of coins (currency) using a decentralized infrastructure. Among the numerous potential advantages of cryptocurrency are efficiencies in monetary exchange due to the elimination of a centralized banking entity.

Cryptocurrency users may store digital assets or coins in a digital wallet, which records the necessary digital information characterizing a particular user's coin holdings. Users may exchange cryptocurrency using their respective wallets.

When transferring funds between wallets, a transaction is executed which details how to move funds from a source account into a destination account. With many cryptocurrencies, transfers of multiple assets require a separate transaction to be performed with respect to each asset to be transferred. This is highly undesirable as parties often seek to transfer multiple assets in a single transaction. For example, a transferring party may own multiple assets and may desire to transfer the entirety of its holdings to a receiving party. Conventional methods are ineeficient because they require the separate transfer of each asset separately.

Thus, techniques are necessary to allow for efficient transfer of multiple digital assets between parties utilizing in a decentralized transaction system.

### BRIEF DESCRIPTION OF THE DRAWINGS

FIG. 1a depicts a process for generating an address and the operation of an entity generation transaction for updating a decentralized ledger to include an entity associated with the address according to an embodiment of the present disclosure.

FIG. 1b depicts an operation of an asset transmission transaction for creating multiple accounts or assets between a first entity and second entity and representing the multiple accounts in a decentralized ledger according to an embodiment of the present disclosure.

FIG. 1c depicts an operation of a key rotation process according to one embodiment of the present disclosure.

FIG. 1d depicts various account transactions initiated by a receiving agent after a transfer of multiple assets has been performed according to one embodiment of the present disclosure.

FIG. 2a is a flowchart depicting a process for performing multiple asset transfers according to an embodiment of the present disclosure.

FIG. 2b is a flowchart depicting a process for the generation of an address from a random seed according to an embodiment of the present disclosure.

FIG. 2c is a flowchart for performing an authentication of a transaction according to an embodiment of the present disclosure.

FIG. 3a depicts a process for the generation of an address from a random seed according to an embodiment of the present disclosure.

FIG. 3b depicts a process for the generation of a transaction triple according to an embodiment of the present disclosure.

FIGS. 3c-3d depicts a process for performing an authentication of a transaction according to an embodiment of the present disclosure.

FIG. 4a is a high level block diagram of a decentralized transaction system according to an embodiment of the present disclosure.

FIG. 4b is a block diagram of a decentralized transaction system according to an embodiment of the present disclosure.

FIG. 4c depicts an example of a ledger in graphical form according to an embodiment of the present disclosure.

FIG. 5a is a high level flowchart of a consensus algorithm according to an embodiment of the present disclosure.

FIG. 5b is a flowchart depicting an operation of a transaction thread according to an embodiment of the present disclosure.

FIG. 5c is a flowchart depicting an operation of a proposal thread according to an embodiment of the present disclosure.

FIG. 5d is a flowchart depicting an operation of a voting thread according to an embodiment of the present disclosure.

FIG. 5e is a flowchart depicting an operation of a proposal generation/validation thread according to an embodiment of the present disclosure.

FIG. 6 is a block diagram of a consensus system according to an embodiment of the present disclosure.

### DETAILED DESCRIPTION

Distributed ledgers are gaining interest for use in a wide variety of transactional systems. For example, many cryptocurrency-based systems use a form of a distributed ledger or similar transaction system to record transactions between holders of cryptocurrencies or similar transactions. As a specific example, a shared distributed ledger may be implemented on a blockchain that records every transaction that occurs in a cryptocurrency system.

Conventional distributed ledgers often record a transaction by creating a record indicating a source address and a destination address, such as digital wallets or other data repositories, and the transaction details such as a number of cryptocurrency or other assets that are transferred from the source address to the destination address, the time at which the transfer occurs, and the like. However, a first user of a decentralized transaction system may own multiple assets. Each asset may be an account with a respective second user indicating that the second user owes the first user some assets. In various instances, the first user may wish to transfer multiple assets to a third user. For example, the first user may want to transfer the entirety of his or her holdings to the first user. In this instance, conventional distributed ledger systems would require that the first user transfer each of the multiple assets one by one to the third user, which is inefficient especially if the first user has a significant number of accounts.

Embodiments disclosed herein provide solutions to this and other aspects of conventional asset transfer systems. Assets may be reflected by an account between two entities in a public ledger. Each entity may be associated with a public key identifier, which allows an owner of a secret key, which was used to generate the public key identifier to perform transactions with respect to the entity. Each entity may be associated with multiple assets or accounts. According to embodiments, a transfer of the multiple assets associated with an entity may be achieved by changing or rotating the public key identifier for the entity to a new public key identifier generated by a transferee from a secret key owned by the transferee. Thus, instead of requiring multiple transactions to be performed with respect to each asset or account, all of the assets/accounts may be transferred using a single transaction.

According to an embodiment of the present disclosure, techniques are disclosed for the transfer of multiple assets between a first agent herein referred to as a transferring agent and a second agent herein referred to as a receiving agent using a single transaction performed in a decentralized transaction system. Each agent may be associated with one or more information elements in the ledger (which may be a decentralized ledger), herein referred to as an entity (defined in detail below), that is addressable within the ledger by virtue of being associated with a unique address (described below)). As will become evident herein, an entity operates as an object for storage of assets and may be associated or owned by an agent by virtue of the agent holding a secret key from which the entity's address is uniquely generated.

According to an embodiment of the present disclosure, the assets associated with an entity may be represented by an account line also referred to as a trust line that represents the indebtedness of a first entity to a second entity with respect to one or more assets. By virtue of the respective association of each entity with an agent, this informational structure facilitates the creation of accounts in the decentralized ledger. The association of an agent with an entity effectively establishes the agent's ownership of assets associated with the entity itself.

In an embodiment, any changes to the state of entities and accounts such as the creation of entities, assignment of an address to an entity, creation of accounts between a first entity and a second entity may require the successful creation, submission, authentication and verification of one or more associated transactions in a decentralized transaction system. According to an embodiment of the present disclosure, transactions submitted to the decentralized transaction system are reflected in a decentralized ledger only if such transactions are authenticated and verified using a decentralized consensus process and system. The decentralized ledger reflects the “ground truth” of trusted transactions in the decentralized transaction system and the operation of consensus operates to establish trust for participants (agents) utilizing the decentralized transaction system.

According to an embodiment of the present disclosure, each entity in the ledger is associated with the respective address, which may be generated from a random seed or secret key. The address serves as an absolute identifier for an entity. According to an embodiment of the present disclosure, the transfer of multiple assets between the transferring agent and the receiving agent may be achieved using a single transaction. In particular, as described in detail below, the transfer of multiple assets between a transferring agent and receiving agent is achieved by performing a key rotation, which may be effected by changing a public key identifier.

### Definitions

Decentralized Transaction System

In addition to its common usage, for purposes of the present disclosure, the term “decentralized transaction system” refers to one or more computing devices that operate collectively to perform transactions between one or more agents (described in detail below). The computing devices may be arranged in a peer-to-peer or similar configuration. As will be described in more detail below, according to an embodiment of the present disclosure, a decentralized transaction system may further include a peer to peer layer, a decentralized consensus layer and a decentralized ledger layer. As will become evident herein, a plurality of servers may operate to independently perform a consensus process wherein such servers interoperate via communication over the peer-to-peer layer for the exchange of information. Further, each server may accept transactions from clients operated by agents, wherein each received transaction effectively represents a candidate change to the decentralized ledger.

Agent

In addition to its common usage, for purposes of the present disclosure, the term “agent” refers to a person, business or other participant in the world utilizing in a decentralized transaction system for the exchange of assets. As will become evident herein, each agent may participate in the decentralized transaction system by using a computing device running a client and associated API, which allows the agent to generate transactions, which may be submitted to the decentralized transactions system for possible inclusion in the decentralized ledger if such transactions are authenticated and validated. Each agent may be associated with one or more entities as described in detail below.

Entity

In addition to its common usage, for purposes of the present disclosure, the term “entity” refers to an object reflected in a virtual double-entry bookkeeping system, for example by utilizing a decentralized ledger, which functions to represent the storage of assets by virtue of accounts established with other entities. As will become evident herein, an entity may operate to reflect one or more accounts through the association of the entity with one or more other entities in a decentralized ledger. Each such association of the entity with another entity may establish a reflected indebtedness, thereby establishing an account. Each entity may be associated with an owner, comprising an agent (defined above). According to an embodiment of the present disclosure, an entity may be associated with a unique address that may be generated from a random seed also referred to a secret key. According to an embodiment of the present disclosure, an entity may also be associated with a public key identifier also referred to herein as a regular key. The public key identifier may be generated from a secret key. The holding of the secret key from which the public key identifier is generate by an agent establishes the ownership of the entity by the agent as it enables the agent to perform transactions with respect to the entity. According to some embodiments, the public key identifier (regular key) of an entity may be rotated or changed to a new public by performing an associated key rotation transaction using the decentralized transaction system.

Account

In addition to its common usage, for purposes of the present disclosure, the term “account” refers to a relationship between two entities indicating that one entity owes the other entity a set amount of assets. In the context of an entity (a double-entry accounting system), an account is associated with a balance that can either be viewed as an asset or a liability depending upon whether it is viewed from the perspective of the entity owing the assets or the entity owed the assets.

Offer

In addition to its common usage, for purposes of the present disclosure, the term “offer” refers to the proposition of trading one asset for another at a given price.

Journal

In addition to its common usage, for purposes of the present disclosure, the term “journal” refers to a chronological (temporal) record of transactions between any number of entities. As will be described in more detail below, according to an embodiment of the present disclosure, a journal may be utilized in a decentralized fashion, whereby multiple peer transaction nodes maintain a respective journal.

Ledger

In addition to its common usage, for purposes of the present disclosure, the term “ledger” refers to a record of the state of all transactions at particular moments in time by account. A ledger records the amount of currency in each agent's account and represents the “ground truth” of a decentralized asset transaction system. As will be described in more detail below, according to an embodiment of the present disclosure, a ledger may be utilized in a decentralized fashion, whereby the ledger is effectively a distributed or decentralized database shared with a plurality of nodes. According to this embodiment, multiple peer-to-peer transaction nodes or servers maintain a list of candidate transactions (described below) in an attempt to reach consensus.

According to an embodiment of the present disclosure, a ledger may be updated on some cadence (e.g., every few seconds using a consensus protocol described in more detail below). The last updated ledger for which consensus has been reached is referred to as the last closed ledger (“LCL”).

Transaction

In addition to its common usage, for purposes of the present disclosure, the term “transaction” refers to any proposed change to the ledger. As will be described in more detail below, in a decentralized transaction network, which may further include a plurality of servers arranged in a peer-to-peer network, any server can introduce a transaction to the network provided by a client. That is, an agent utilizing an associated client and API (for example, wherein such client and API execute on a computing device) may submit a transaction to a decentralized transaction system by submitting the transaction to a server. The submitted transaction then assumes a state as a proposed change/modification to the ledger, which may ultimately be reflected in an updated ledger if such transaction is authenticated and verified.

Consensus

In addition to its common usage, for purposes of the present disclosure, the term “consensus” refers to a process that may be execute in a distributed fashion for achieving agreement with some mathematical certainty about one or more transactions to be applied to the ledger with respect to authentication and verification. Consensus functions to establish trust in a decentralized transaction system that would otherwise be established by virtue of a centralized authority such as a bank, which may be backed by a governmental entity. In particular, a consensus process, which may operate in a decentralized fashion, seeks to authenticate each transaction (ensure such transaction was generated by an agent authorized to perform such transaction) as well as verify each transaction (ensure such transaction is valid). An example of an invalid transaction, for example, would be an attempt by an agent to perform double spending, i.e., perform two transactions with respect to an account that in aggregate exceeded the asset limit in the account.

According to an embodiment of the present disclosure, a transfer of multiple assets between a transferring agent and receiving agent may be performed by the following process. The transferring agent owns a first entity, which is represented in a ledger. The ownership of the first entity by the transferring agent is established by virtue of the transferring agent possessing a first secret key (random seed) from which first public/private keys and a first address may be generated using a deterministic address generation process. The entity is associated with a public key identifier which may comprise the first address, which allows for the transferring agent to perform transactions with respect to the first entity thereby establishing the transferring agent's control/ownership of the first entity. That is, by virtue of the transferring agent owning the first secret key, the transferring agent is able to authenticate transactions with respect to the first entity. The first entity is further associated with multiple accounts (assets) in the ledger wherein each account represents an indebtedness of assets from a respective second entity to the first entity.

The receiving agent chooses a second secret key and performs an identical address generation process to the first address generation process (described above) by which second private/public keys and a second address are generated. The receiving agent provides the generated second address to the transferring agent. Because the transferring agent owns and controls the first entity, the transferring agent may then perform a transaction with respect to the first entity for rotating the public key identifier associated with the first entity to the second address provided by the receiving agent. By performing the key rotation, ownership of the entity and all of its associated accounts is effectively transferred to the second agent, which is now authenticated to perform transaction with respect to the first entity by virtue of possessing the second secret key. The transfer of the multiple assets between the first agent and the second agent is reflected in the ledger through the key rotation transaction, which must be approved by, for example, a consensus process, which may be performed in a decentralized fashion. That is, the transfer of multiple assets between a first agent (transferring agent) and second agent (receiving agent) is achieved by performing a single key rotation transaction avoiding the transferring agent having to perform a series of transactions for each account/asset.

According to an alternative embodiment, the first entity may be associated with a master key and a first regular key, each of which include respective private/public keys and secret keys. The first entity may be represented in a ledger, which may be decentralized. Multiple accounts may be established for the first entity in the ledger comprising respective relationships between the first entity and a respective second entity indicating a corresponding respective indebtedness between the second entity to the first entity. The master and first regular key may be generated by a deterministic process from a first secret key chosen by the transferring agent. The transferring agent may disable the master key, which then allows the transferring agent to perform transaction using the first regular key. The receiving agent may then generate a second regular key by choosing a second secret key. The receiving agent may then provide the second regular key to the transferring agent. The transferring agent may then perform a key rotation, rotating the first regular key to the second regular key thereby performing a transfer of multiple assets (accounts) associated with the transferring agent to the receiving agent.

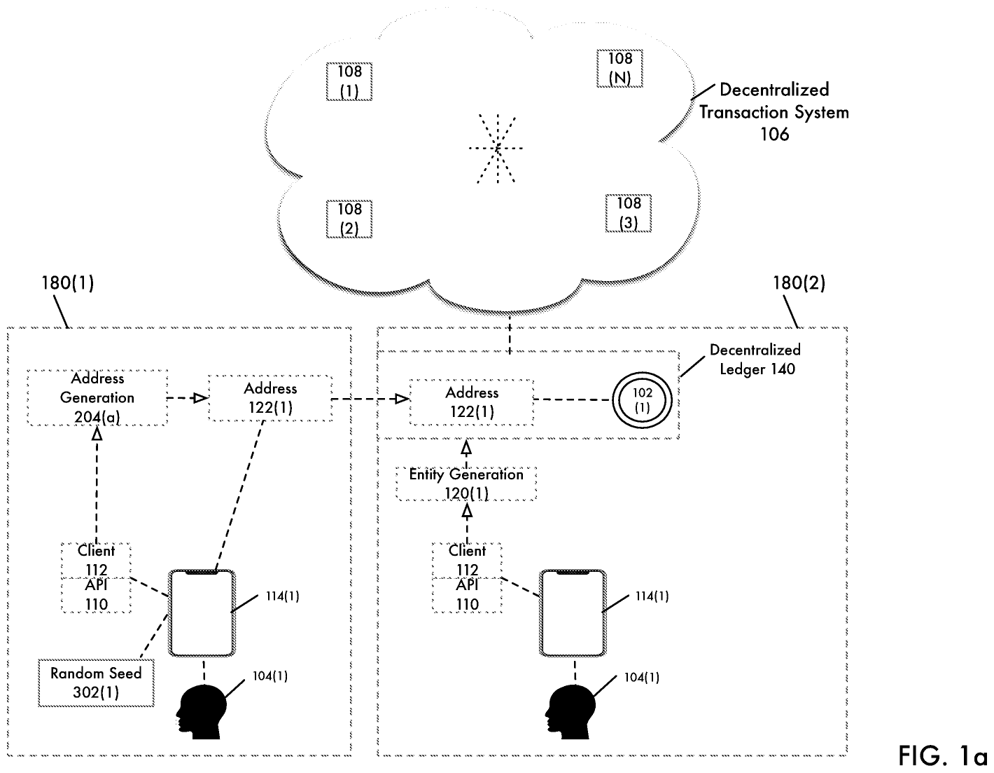

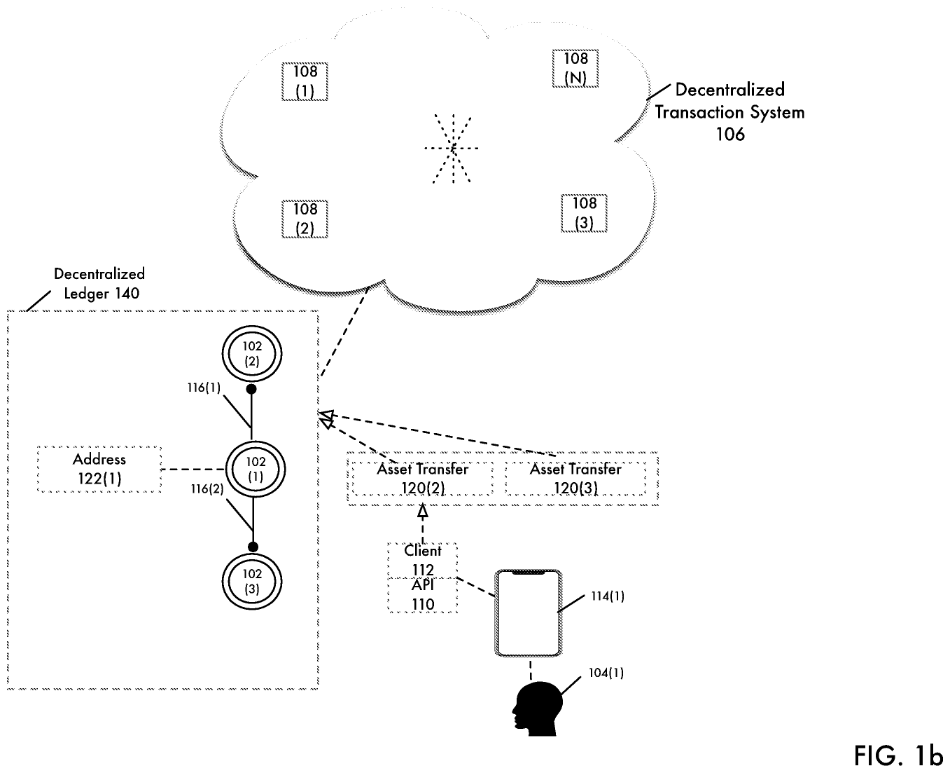

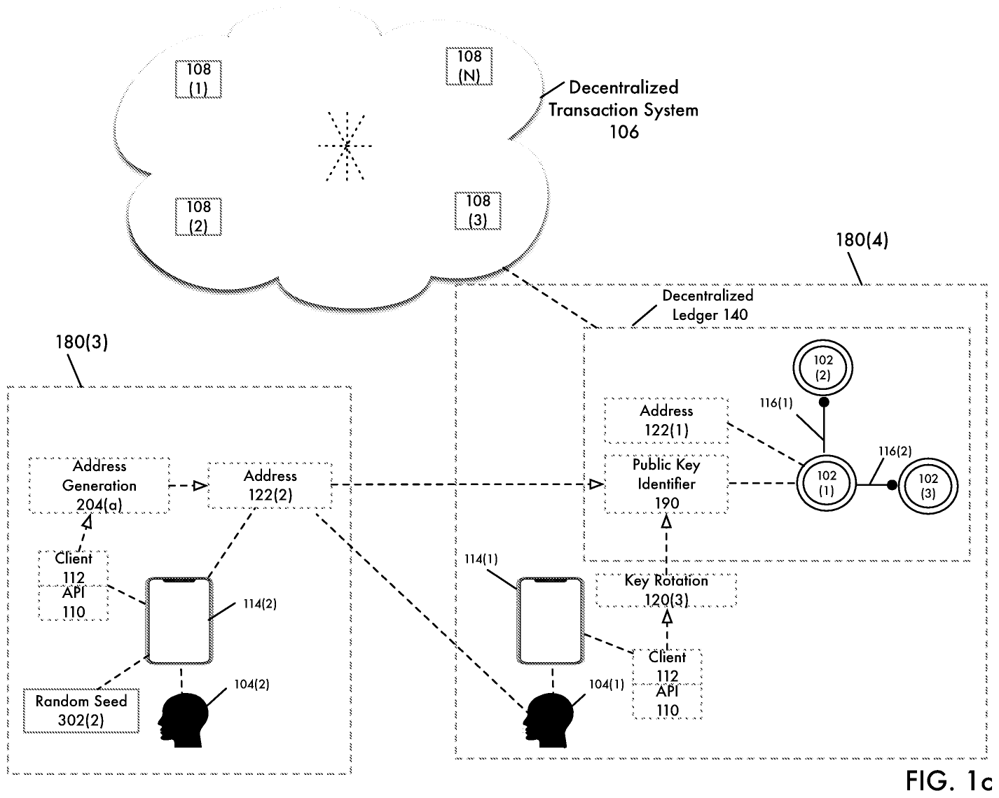

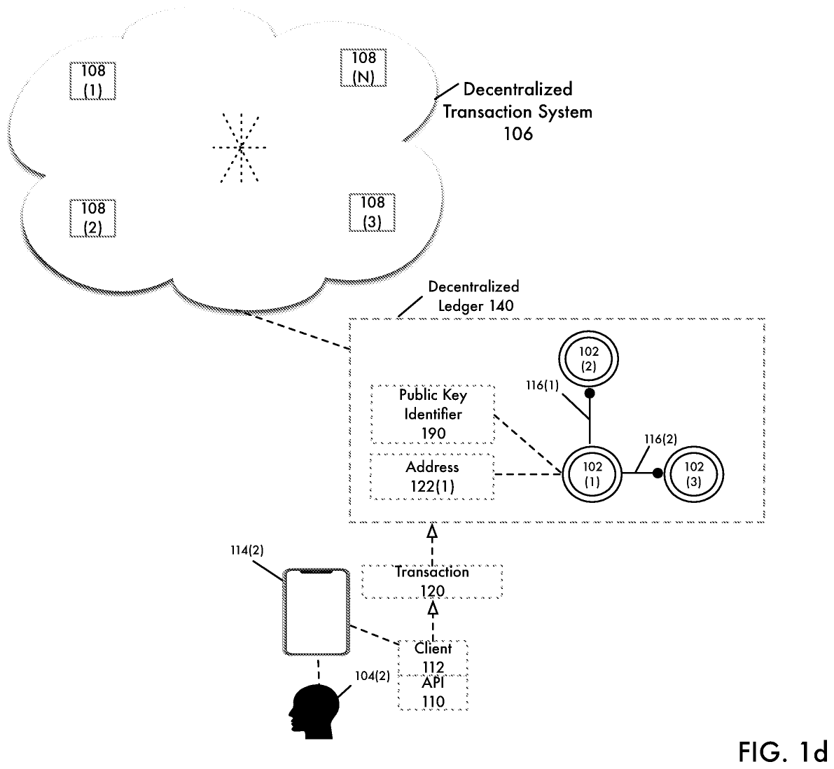

FIGS. 1a-1d depict a method for a transfer of multiple digital assets/accounts between a transferring agent and a receiving agent according to an embodiment of the present disclosure. In particular, FIG. 1a depicts an address generation process initiated by first agent 104(1) for creating a first address 122(1) owned by first agent 104(1) and an entity creation transaction for generating first entity 102(1) and its association with first address 122(1) in a decentralized ledger according to an embodiment of the present disclosure. Referring now to FIG. 1a, agent 104(1) utilizes computing device 114(1) to interact with client 112 via API (“Application Programming Interface”) 110 to execute transactions that are to be reflected in decentralized ledger 140. Although the embodiment described with respect to FIGS. 1a-1d pertain to operations on a decentralized ledger 140, it will be understood that according to alternative embodiments, transactions may be performed with respect to a centralized ledger or some other bookkeeping entity or system. Further, as will be described below, for purpose of this discussion the terms “decentralized ledger” 140 and “decentralized ledger layer” are used interchangeably as contextually appropriate.

An example structure of a transaction will be described in due course. For purposes of the present discussion, it is sufficient to recognize that a transaction may be initiated by an agent reflecting a proposed change to decentralized ledger 140 or some other bookkeeping system for representing account information with respect to a plurality of agents 104. Decentralized transaction system 106 may include an arbitrary number of servers 108(1)-108(N), which may operate in a peer-to-peer network. The operation and structure of a peer-to-peer network will be understood. However, for purposes of the present discussion, it is sufficient to recognize that a peer-to-peer network may include any collection of resources that may communicate without the need for any centralized coordination such as via a central server, for example. Servers 108(1)-108(N) may operate to collectively perform consensus operations with respect to transactions initiated on decentralized transaction system 106 and relatedly maintain and update decentralized ledger 140. For example, each server 108(1)-108(N) may maintain a respective journal of transactions initiated by clients 112 running on respective computing devices (e.g. 114(1)).

Computing device 114(1) may be any device associated with a central processing unit such as a desktop computer, a mobile device, a tablet device, electronic watch, etc. Agent 104 may interact with computing device 114 using any method such as a keyboard and mouse, voice, etc. Client 112 may include any process, framework or other software based structure executing on client 114(1) that allows agent 104(1) to interact with decentralized transaction system 106. According to an embodiment of the present disclosure, client 112 operates as a digital wallet for performing transactions using decentralized transaction system 106 with respect to one or more entities 102 associated with an agent 104. Agent 104 may utilize client 112 to initiate transactions on decentralized transaction system 106 by interacting with one of the servers 108(1)-108(N). That is, agent 104 may desire to perform a particular transaction with respect to decentralized transaction system 106.

Client 112 may provide an interface (graphical or otherwise) by which agent can select various functions accessible via API 110 for initiating a transaction with respect to decentralized transaction system 106. Client 112 may then perform a processes to generate an appropriate transaction in an appropriate data format for submission to decentralized transaction system 106, which will then become a candidate transaction for possible inclusion in a ledger, for example, if consensus is reached with respect the transaction. As previously noted, example data structures and processes for generating a suitable data entity for representation of a transaction for submission to decentralized transaction system 106 will be discussed in due course.

As shown in the embodiment depicted in FIG. 1a, API 110 and client 112 are executed on computing device 114(1) and operate as a digital wallet enabling agent 104(1) to perform asset transactions via interactions with decentralized transaction system 106, which are recorded in decentralized ledger 140. As will be appreciated, API 110 provides an interface for calling various methods on client 112. For example, according to an embodiment of the present disclosure, API 110 may provide methods to create an entity 102 in decentralized ledger 140, create a transaction between a first entity 102 and a second entity 102, establish an offer, etc.

API 110 may include any interface for interacting with client 112. According to the embodiment depicted in FIGS. 1a-1d, API 110 and client 112 may execute on computing device 114(1). According to some embodiments, API 110 and client 112 may execute on a remote server in which case, API 110 may include, for example, a RESTful (“Representation State Transfer”) interface, an RPC (“Remote Procedure Call”) interface or any other interface. API 110 may be associated with a set of methods, which are functions or API calls that may be performed with respect to decentralized transaction system 106.

According to an embodiment of the present disclosure and as discussed in more detail below, each API method may use a transaction field, a transaction signature field and a public key field. The transaction field may include an identifier in either ASCII or binary format specifying the desired transaction. The transaction signature file may include a binary string that is generated by performing a signature operation on the transaction identifier using a public key that was generated from an address 122. The public key field may include a public key that was generated from the random seed 302 that was used to generate address 122.

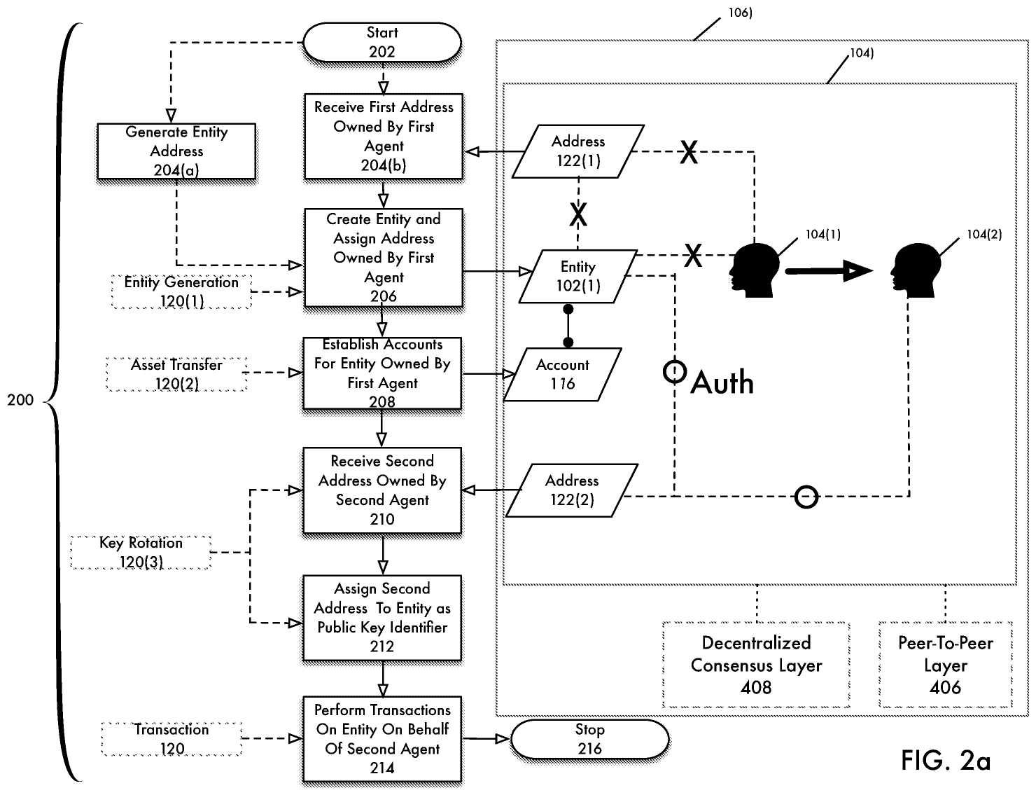

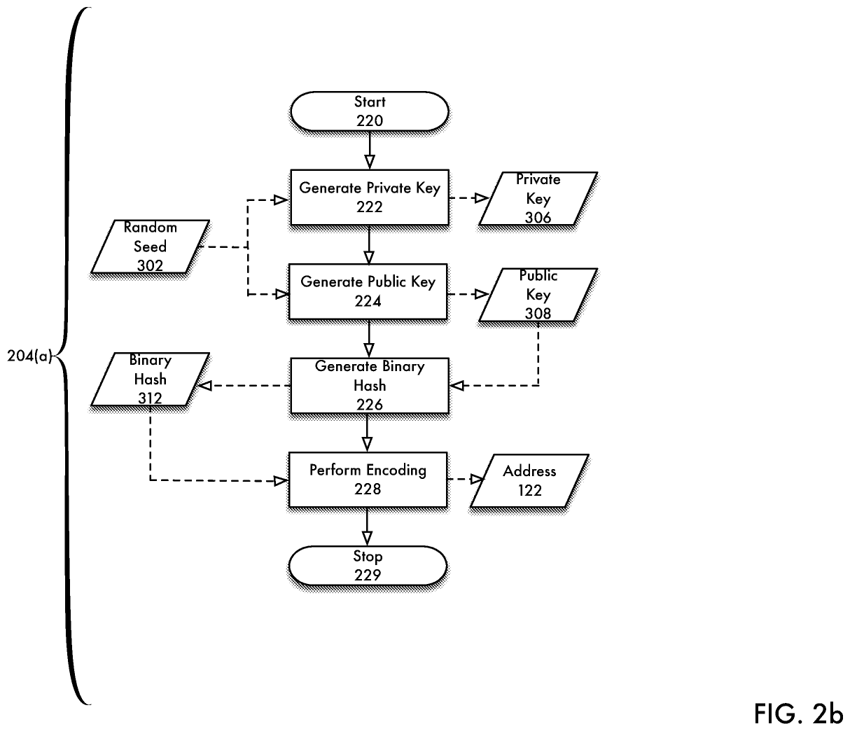

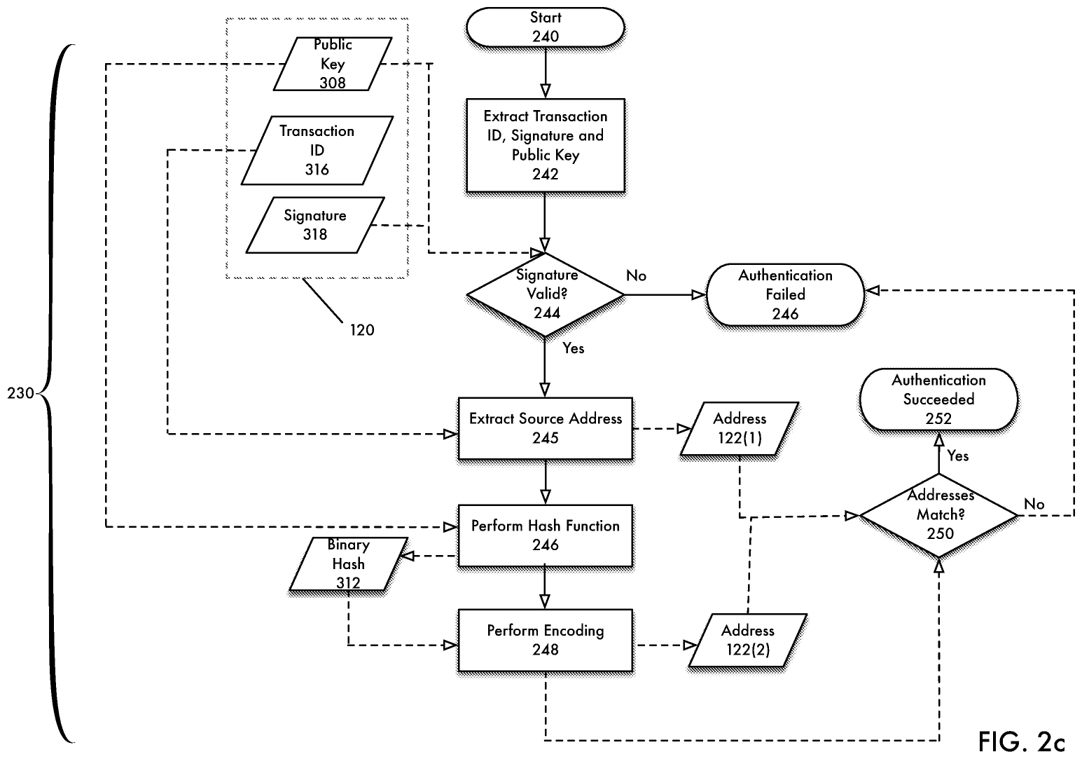

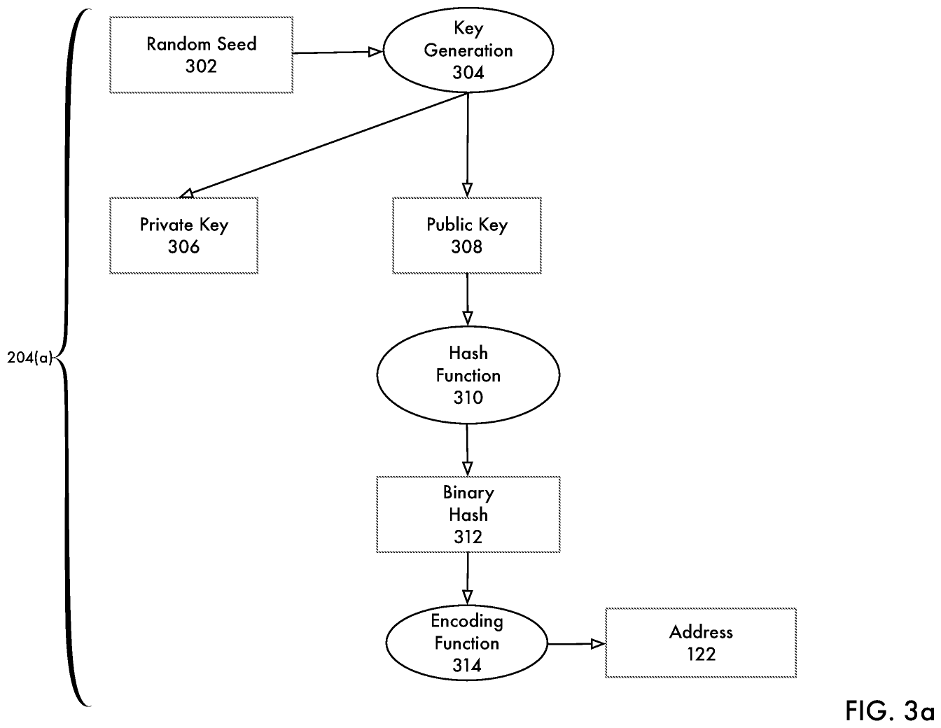

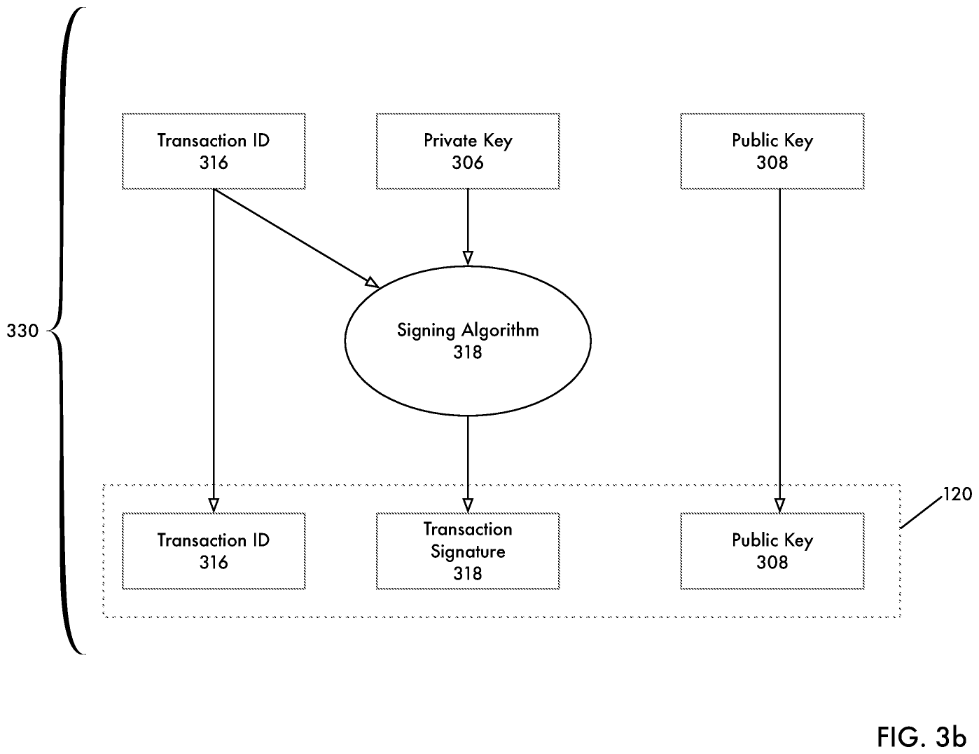

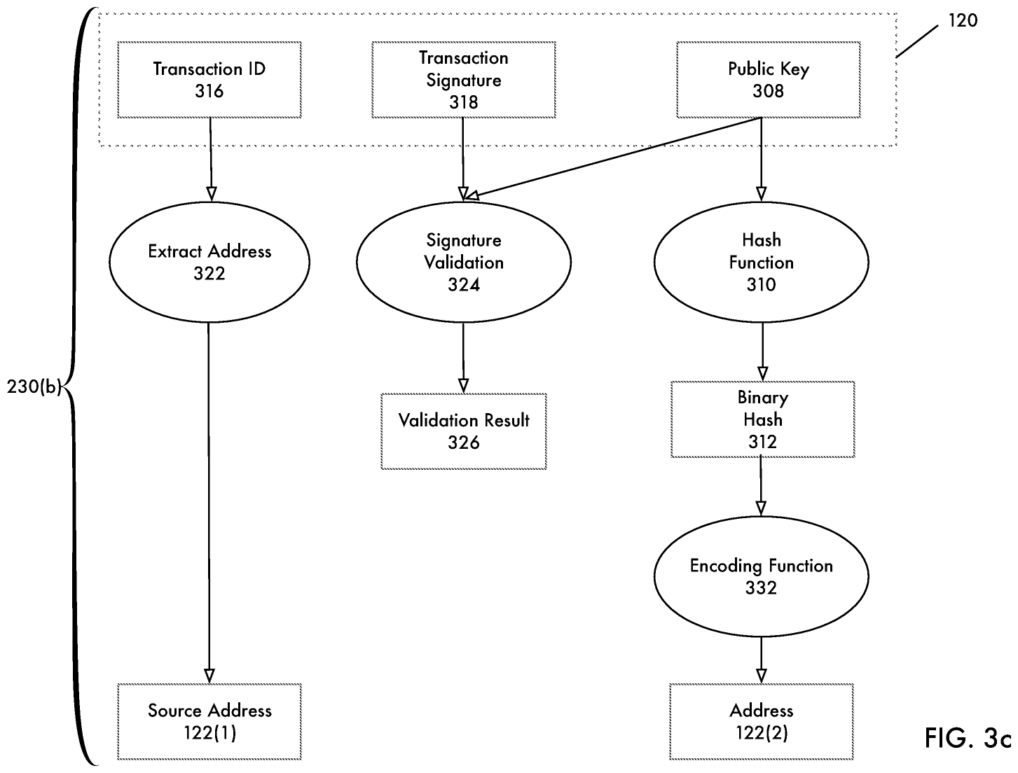

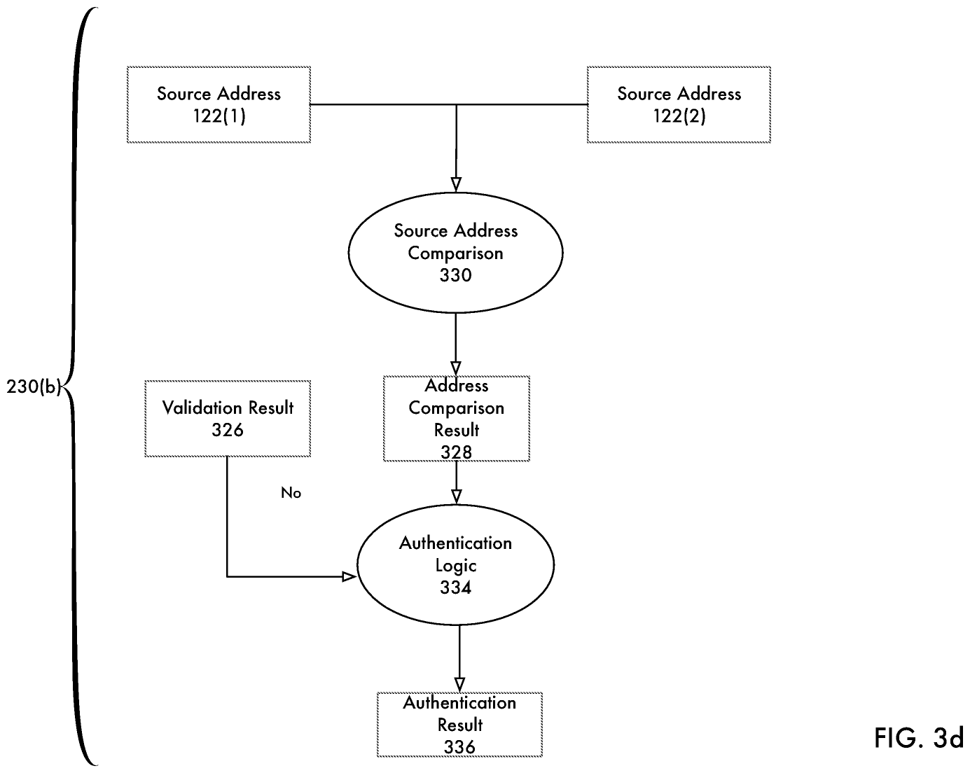

In 180(1), agent 104(1) uses computing device 114(1) to interact with API 110 to invoke method calls on client 112 to invoke address generation process 204(a), which produces address 122(1). A detailed description of address generation process 204(a) is described below with respect to FIGS. 2b and 3a. For purposes of the present discussion, however, it is sufficient to recognize that agent 104(1) may select a secret key also referred to herein interchangeably as a random seed 302(1) from which address 122(1) is generated. The random seed/secret key 302 is privately held by agent 104(1) such that only agent 104(1) can generate associated address 122(1) due to the fact that the address generation process 204(a) utilizes a one-way function. That is, according to an embodiment of the present disclosure and as described in more detail below, the address generation process 204(a) provides a bijective mapping between the random seed 302(1) and address 122(1). Address 122(1) generated in 180(1) may serve as a unique identifier for an entity.

180(2) shows a process for generation of an entity 102(1) and association of entity 102(1) with address 122(1) generated in 180(1). In particular, in 180(2), ledger 140 is updated to reflect entity 102(1) and its association with address 122(1). According to an embodiment of the present disclosure, entity 102(1) may be generated in decentralized ledger 140 by agent 140(1) causing the generation of an entity generation transaction 120(1), for example, by calling a dedicated API method on API 110 that causes the submission of transaction 120(1) to decentralized transaction system 106. As will be described below, decentralized transaction system 106 receives transaction 120(1), which initially is only a candidate transaction for inclusion in decentralized ledger 140. In particular, if entity generation transaction 120(1) is authenticated and validated by decentralized transaction system 106, for example via a consensus process carried out in a decentralized fashion, a new entity 102(1) is initialized in decentralized ledger 140 such that it is associated with address 122(1) generated in 180(1).

As previously noted, entity generation transaction 120(1) represents one of many potential transactions 120 to be performed with respect to decentralized transaction system 106. The structure of an example transaction 120 will be described in detail below. According to alternative embodiments, other arrangements are possible with respect to the generation of entity 102(1) and its association with address 122(2) in decentralized ledger 140. For example, according to an alternative embodiment, entity 102(1) and its association with address 122(1) is automatically registered in decentralized ledger 140 when agent 104 initiates a transaction to transfer assets to another entity 102. In particular, according to this alternative embodiment, agent 104 generates an address 122(1) generated using a process shown in 180(1). Agent 104 may then transmit assets by calling an API method to generate a transaction for transmitting assets to another entity 102. By virtue of performing the asset transfer and using the address 122 generated in 180(1), a new entity 102(1) is generated automatically in decentralized ledger 140.

According to yet another embodiment of the present disclosure, entity 102(1) and its association with an address 122(1) may be generated in decentralized ledger 140 upon a transaction initiated by a different agent 104 for transferring assets to agent 104(1). According to this alternative embodiment, agent 104 may generate an address via the process shown in 108(1) and then provide the address to a transferring agent 104. The transferring agent 104 may then initiate a transaction with respect to decentralized transaction system 106 for the transfer of assets to agent 104(1) using address 122(1). This transaction 120 may then cause the generation of entity 102(1) and its association in decentralized ledger 140.

As previously noted, decentralized ledger 140 is only updated or closed to include new entity 102(1) and its associated address 122(2) if the transactions causing such actions are authenticated and validated by distributed transaction system 106. Example methods for operation of a consensus process associated with decentralized transaction system 106 are described in detail below. Thus, although FIG. 1a depicts the direct updating of decentralized ledger 140 via entity generation transaction 120(1), it will be understood that entity generation transaction 120(1) must undergo a consensus process (described in detail below) before decentralized ledger 140 is updated to reflect entity 102(1) and its associated address 122(1).

FIG. 1b depicts an operation of an asset transmission transaction for creating multiple accounts or assets between a first entity 102(1) and second entity 102(2) according to an embodiment of the present disclosure. As shown in FIG. 1b, agent 104(1) interacts with computing device 114(1) to perform an appropriate method call via API 110 to cause client 112 to initiate a first asset transfer transaction 120(2) via decentralized transaction system 106 between entity 102(1) and entity 102(2). Upon authentication and verification of asset transfer transaction 120(2) via decentralized transaction system 106 (described in detail below) account 116(1) is generated in decentralized ledger 140 with respect to entities 102(1) and 102(2). That is, in transferring the assets between entity 102(1) owned by agent 104(1) and entity 102(2), entity 102(2) now owes entity 102(1) in the amount of the assets transferred.

Similarly, as shown in FIG. 1b, agent 104(1) interacts with computing device 114(1) to perform an appropriate method call via API 110 to cause client 112 to initiate a second asset transfer transaction 120(3) via decentralized transaction system 106 between entity 102(1) and entity 102(3). Upon authentication and verification of asset transfer transaction 120(3) via decentralized transaction system 106 (described in detail below) account 116(2) is generated in decentralized ledger 140 with respect to entities 102(1) and 102(3). That is, in transferring the assets between entity 102(1) owned by agent 104(1) and entity 102(3), entity 102(3) now owes entity 102(1) in the amount of the assets transferred.

Thus, two accounts/assets 116(1) and 116(2) have been created with respect to entity 102(1). In particular, as shown in FIG. 1b, the solid black dot on the line connecting entity 102(1) and 102(2) indicates that entity 102(2) owes entity 102(1) in the amount of the transferred assets to entity 102(2). Correspondingly, the agent associated with entity 102(2) (not shown in FIG. 1b) owes agent 104(1) in the amount of the transferred assets between entity 102(1) and entity 102(2). Similarly, the solid black dot on the line connecting entity 102(1) and 102(3) indicates that entity 102(3) owes entity 102(1) in the amount of the transferred assets to entity 102(3). Correspondingly, the agent associated with entity 102(3) (not shown in FIG. 1b) owes agent 104(1) in the amount of the transferred assets between entity 102(1) and entity 102(3).

FIG. 1c depicts an operation of a key rotation process according to one embodiment of the present disclosure. Referring to FIG. 1c, in phase 180(3), agent 104(2) uses computing device 114(2) to interact with API 110 to invoke method calls on client 112 to invoke address generation process 204(a), which outputs address 122(2). A detailed description of address generation process 204(a) is described below with respect to FIGS. 2b and 3a. As previously described with respect to FIG. 1a, it is sufficient to recognize that agent 104(2) may select a random seed 302(1) also referred to herein as a random secret key from which address 122(1) is generated. The random seed/secret key 302(1) is owned by agent 104(2) and address generation process 204(a) provides a bijective mapping between the random seed 302(2) and address 122(2). Agent 104(2) may then provide address 122(2) generated in 180(3) to agent 104(1).

In 180(4) agent 104(1) uses computing device 114(1) to interact with API 110 to cause client 112 to initiate a key rotation transaction 120(3). As with any initiated transactions 102, key rotation transaction 120(3) must be authenticated and validated via a consensus process performed by decentralized transaction system 106 before the key rotation is updated in decentralized ledger 140. Upon validation and authentication, key rotation transaction 120(3) causes address 122(2) owned by agent 104 (generated in 180(3)) to be associated with entity 102(1) as public key identifier 190 (also referred to herein as a regular key) in decentralized ledger 140. As a result of associating address 122(2) with entity 102(1) as its public key identifier 190, agent 104(2) who holds address 122(2) (because agent 104(2) holds the secret key, which uniquely generates address 122(2)) can now perform transactions 120 with respect to entity 102(2). In particular, agent 104(2) can now be uniquely authenticated with respect to transactions 120 bearing on entity 102(1) because agent 104(2) holds the secret key from which public key identifier 190 was generated, so long as those initiated transactions 120 are valid, agent 104(2) effectively owns assets associated with entity 102(1). In particular, agent 104(2) now owns accounts 116(1) and 116(2) and thereby a transfer of multiple assets associated has been effected.

Although the example described with respect to FIGS. 1a-1c involved the transfer of two assets/accounts 116(1)-116(2), it will be understood that a similar process could be performed for the transfer of an arbitrary number of assets/accounts 116.

FIG. 1d depicts various account transactions initiated by a receiving agent after a transfer of multiple assets has been performed according to one embodiment of the present disclosure. That is, FIG. 1d illustrates the fact that upon performing key rotation as shown in FIG. 1c, the receiving agent 104(2) owns entity 102(1) and all associated accounts and can interact with decentralized ledger 140 as such because receiving agent 104(2) owns the secret key from which public key identifier 190 was generated).

According to an embodiment, an entity 102 may be associated with a master key (comprising corresponding public and private master keys) and a regular key (comprising corresponding public and private regular keys). If the master key is disabled, the regular key may be used to perform authentication with respect to transactions 120 performed for entity 102(1). An API method may be provided for initiating a transaction 120 for rotation of the regular key with respect to entity 102, which may be updated in decentralized ledger 140 if such key rotation transaction is authenticated and validated. The transferring agent 104 of the assets may disable the master key associated with entity 102 and assign a regular key, which allows the agent 104 owning the assets to perform transactions 120 using the regular key. The intended transferee agent 104 of assets may then generate a regular key from a random seed 302 using a key generation process. The intended transferee agent 104 of the assets may then transmit the public key for the new regular key to agent 104 currently owning the assets. The transferring agent 104 may then initiate a key rotation transaction 120 whereby the key associated with entity 102 is now assigned to the key provided by the intended transferee agent 104. Because the intended transferee agent 104(2) owns the secret key/random seed 302 associated with the public key, which has been set in decentralized ledger 140 for the entity 102(1), the intended transferee agent 104(2) now owns the multiple assets 116(1)-116(2) associated with entity 102(1).

FIG. 2a is a flowchart depicting a process for a transfer of multiple assets according to an embodiment of the present disclosure. The process shown in FIG. 2a may be understood as pertaining to the process steps shown in FIGS. 1a-1d from the perspective of a decentralized transaction system or centralized transaction system. As will be evident from the discussion with respect to FIGS. 1a-1d, multiple transfer of assets process 200 may be accomplished with respect to a decentralized ledger 140 in the context of a decentralized transaction system 106. Thus, as previously noted, and as described in more detail below, servers 108(1)-108(N) operate among other things to perform a consensus process over peer-to-peer layer 406 using decentralized consensus layer 408 with respect to transactions 120 initiated by clients 112. Transactions that are authenticated and verified are referred to herein as transactions for which consensus has been reached and decentralized ledger 140 is updated to reflect transactions that have reached consensus. In particular, the updating of decentralized ledger 140, is performed by decentralized transaction system 106, which further includes decentralized leger 104, decentralized consensus layer 408 and peer-to-peer layer 406 all of which will be described in more detail below.

Thus, for purposes of discussion with respect to FIG. 2a, it is assumed and not explicitly stated that any transactions 120 that are received and then updated in decentralized ledger 140 are transactions 120 for which decentralized consensus layer 408 has reached consensus. Furthermore, according to alternative embodiments, the process shown in FIG. 2a may be understood to occur at a single node or other computational element rather than using decentralized transaction system 106. It is further assumed for purposes of this example, that agents 104(1) and 104(2) generate respective transactions 120 via respective clients 112 and APIs 110 running on respective computing devices 114 operated by agents 104(a) and 104(b).

Referring to FIG. 2a, according to an embodiment of the present disclosure, in general transfer of multiple assets process 200 is performed by updating decentralized ledger 140 to reflect a change of ownership of an entity 102(1) from agent 104(1) to 104(2). This change of ownership for entity 102(1) from agent 104(1) to 104(2) may be effected through the receipt of one or more transactions 120 and that have reached consensus via decentralized consensus layer 408 and are thereby then reflected in decentralized transaction system 140. The particular example of a set of transactions 120 received for updating decentralized ledger 140 to effect the asset transfer between agents 104(1) and 104(2) is merely one example and many other possibilities are possible.

As previously noted, for purposes of explanation, it will be understood that any updates to decentralized ledger 140 based upon transactions 120 submitted to decentralized transaction system 106 are only performed if such transactions 120 are authenticated and verified via decentralized consensus layer 406 although this consensus process is not explicitly stated with respect to the transactions 120 described with respect to FIG. 2a.

Referring now to FIG. 2a, multiple asset transfer process 200 is initiated in 202. Process steps 204(a), 204(b) and 206 pertain to 180(a) and 180(b) in FIG. 1a. In 204(b), first entity address 122(1) owned by a first agent 104(1) is received. In particular, it is assumed that an address generation process 204(a) has been performed by first agent 104(1). A detailed description of an address generation process 204(a) is described below with respect to FIGS. 2b and 3a. According to an embodiment of the present disclosure, entity address 122(1) is generated on client 112 from random seed 302 selected by agent 104(1). However, according to alternative embodiments, address 122(1) may be generated within decentralized transaction system 106 upon receipt of random seed 302 provided by agent 104(1). For example, entity address 122(1) may be generated by one of servers 108(1)-108(N) comprising decentralized transaction system 106. Thus, as shown in FIG. 2a, alternate address generation process 204(a) is shown indicating an embodiment where entity address 122 is generated within decentralized transaction system 106.

As will be described briefly below, according to yet another embodiment, neither process steps 204(a) and 204(b) are performed at all and generation of entity 102(1) is performed automatically upon submission of a transaction 120 and its consensus by decentralized consensus layer 408 for the transfer of assets pertaining to the transfer of assets to entity 102(1) from another entity owned by a different agent 104.

In 206, upon receipt of entity generation transaction 120(1) and such transaction 120(1) reaching consensus, entity 102(1) is created and address 122(1) is assigned to entity 102(1). According this embodiment of the present disclosure, a specific API method may be provided by which agent 104(1) may create entity 102(1) in decentralized ledger 140 by submitting entity generation transaction 120(1) (using computing device 114 executing API 110 and client 112) and entity generation transaction 120(1) reaching consensus via decentralized transaction layer 408. According to an embodiment of the present disclosure, entity 102(1) may be created automatically upon the transfer of assets from another entity (i.e., other than 102(1)) to entity 102(1). This may be performed, for example, by an agent 104 who owns a transferring entity 102 (not shown in FIG. 2a) by performing a transaction 120 to transfer assets to entity 102(1) by submitting an appropriate transaction 120 for the transfer of assets to entity 102(1). In particular, this may be accomplished, for example, by the agent 104(1) having generated address 122(1) providing address 122(1) to the transferring agent 104 (not shown in FIG. 2a).

Process step 208 pertains to the process steps shown in FIG. 1b. In 208, upon receipt and achieved consensus with respect to asset transfer transactions 120(2) and 120(3), accounts 116(1) and 116(2) are established with respect to entity 102(1). As previously described, accounts 116(1)-116(2) represents a relationship between entity 102(1) and other respective entities 102 (not shown in FIG. 2a) indicating a transfer of assets from entity 102(1) to the other entity such that an indebtedness is established between the other entities and entity 102(1) (i.e., the other entity owes entity 102(1) the transferred assets).

Process steps 210-212 pertain to the process steps shown in FIG. 1c. In 210-212, receipt and consensus having been reached with respect to key rotation transaction 120(3) causes second address 122(2) owned by second agent 104(2) to be received and that address 122(2) to be assigned to entity 102(1) as public key identifier 190. It is assumed, that second agent 104(2) has generated second address 122(2) via an address generation process as described with respect to 204(a). As shown in FIG. 2a, according to an embodiment of the present disclosure, the transfer of address 122(1) to 122(2) with respect to entity 102(1) may be accomplished by performing a key rotation process, second address 122(1) is assigned to public key identifier 190. By performing the key rotation process, the power to authenticate transactions 120 with respect to entity 102(1) is effectively transferred by agent 104(1) to agent 104(2). According to alternative embodiments, as previously mentioned, a key rotation process may be utilized whereby a master and regular key may be associated with entity 102(1) explicitly.

In 214, transactions 120 are performed with respect to entity 102(1) on behalf of agent 104(2). That is, by virtue of the key rotation process described, agent 104(2) now owns the assets associated with accounts 116(1) and 116(2)). The process ends in 216.

At this point a transfer of multiple assets (i.e., accounts 116(1)-116(2)) has been achieved from agent 104(1) to agent 104(2). This transfer of multiple assets from agent 104(1) to 104(2) is achieved effectively by the transfer of authentication power between agent 104(1) and 104(2) with respect to entity 102(1). This transfer of authentication power will be described in detail below with respect to FIGS. 2b-2c. For purposes of the present disclosure, the transfer of authentication power between agent 104(1) and 104(2) may be understood to be achieved due to the fact that the power to authenticate is controlled by the owner of the private key associated with public key identifier 190 assigned to the entity 102. As will become evident below, the private key is utilized to generate a transaction signature. Before any transactions 120 can be effected with respect to an entity 102, the signature must be validated using a public key associated with the private key that was used to sign the transaction 120. Furthermore, authentication may require that the address 122 provided in a transaction 120 (as described below) must match the source address 122 associated with the public key (also provided in the transaction 120).

FIG. 2b is a flowchart depicting a process for the generation of an address from a random seed according to an embodiment of the present disclosure. The process shown in FIG. 2b pertains to 204(a) in FIG. 2a. As previously described, an address 122 may be associated with an entity 102 in order to allow a particular agent 104 to perform authenticate transactions 120 with respect to that entity 102. The process is initiated in 220. In 222, private key 306 is generated from random seed 302. In 224, public key 308 is generated from random seed 302. According to an embodiment of the present disclosure, generation of private key 306 and public key 308 are performed using a one-way function using random seed 302. In 226, binary hash 312 is generated from public key 308. According to an embodiment of the present disclosure, binary hash 312 is generated using a one-way function. In 228, an encoding process is performed to generate address 122 from binary hash 312. According to an embodiment of the present disclosure, generation of address 122 from binary hash 312 is performed using a two-way function. The process ends in 229.

FIG. 2c is a flowchart for performing an authentication of a transaction according to an embodiment of the present disclosure. Transaction authentication process 230 may be performed with respect to any transactions 120 received in decentralized transaction system 106. For a proposed transaction to be included in decentralized ledger 140, both authentication and verification may be required. FIG. 2c specifically shows an authentication process that may be performed by a single server 108. Upon authentication, in order for a proposed transaction 120 to be verified and thereby reflected in decentralized ledger 140, it may be expected or required for decentralized consensus layer 408 (described below) to reach consensus with respect to that transaction 120. The operation of decentralized consensus layer 408 is described in detail below.

According to an embodiment of the present disclosure, each transaction 120 may be a triple comprising public key 308, transaction ID 316 and transaction signature 318. The structure and a process for generation of a transaction 120 will be described in detail below with respect to FIG. 3b. According to an embodiment of the present disclosure, agent 104 utilizes computing device 114 to generate a transaction 120. In 242, transaction 120 is received and the various components of the triple (public key 308, transaction ID 316 and signature 318) are extracted. In 244, it is determined whether transaction signature 318 is valid. If not (‘No’ branch of 244), authentication fails in 246. If so (‘Yes’ branch of 244), flow continues with 245 where the source address 122(1) is extracted from transaction ID 316. In particular, according to an embodiment of the present disclosure, the address 122 associated with the entity 102 for which a transaction 120 is to be performed is embedded in transaction ID 316.

In 246, a hash function is applied to public key 308 to generate binary hash 312. In 248 binary hash is encoded to generate address 122(2). In 250, it is determined whether address 122(1) matches address 122(2). If not (‘No’ branch of 250), authentication fails in 246. Otherwise (‘Yes’ branch of 250), authentication succeeds in 252 and the transaction 120 may be performed.

FIG. 3a depicts a process for the generation of an address from a random seed according to an embodiment of the present disclosure. The process flow in 3a mirrors the flowchart shown in FIG. 2b. Random seed 302 is processed by key generation process 304, which generates private key 306 and public key 308. Public key 308 is processed by hash function 310, which generates binary hash 312. Binary hash 312 is processed by encoding function 314, which generates address 122.

FIG. 3b depicts a process for the generation of a transaction according to an embodiment of the present disclosure. As previously discussed, transaction 120, which may include a triple of a transaction ID 316, transaction signature 318 and public key 308 is transmitted by client 112 in order to initiate an attempted update to decentralized ledger 140 in decentralized transaction system 106. As shown in FIG. 3b, transaction ID 316 and private key 306 are provided to signing algorithm 318, which generates transaction signature 318. Transaction signature 120 is then assembled as a triple comprising transaction ID 316, transaction signature 318 and public key 308.

FIGS. 3c-3d depicts a process for performing an authentication of a transaction according to an embodiment of the present disclosure. The process shown in FIGS. 3c-3d mirrors the flowchart shown in FIG. 2c. In particular, transaction authentication process shown in FIGS. 3c-3d determines both whether an address, which may be regenerated from transaction 120 matches address 122(2) received from public key 122(2) and whether transaction signature 318 is valid.

Referring to FIG. 3c, which shows a first phase of a transaction authentication process, address 122(1) is extracted from transaction 120 using address extract process 322. Meanwhile, transaction signature 318 is processed by signature validation process 324 using public key 308 to generate validation result 326 indicating whether transaction signature 318 is valid or not. In addition, public key 308 is processed by hash function process to generate binary hash 312. Binary hash 312, in turn, is processed by encoding function 332 to generate address 122(2).

Referring now to FIG. 3d, which shows a second phase of a transaction authentication process, source addresses 122(1) and 122(2) are compared by source address comparison process 330 to generate address comparison result 328. Then, validation result 326 and address comparison result 328 are processed by authentication logic process 334 to generate authentication result 336. In particular, if both transaction signature 318 is valid and source addresses 122(1) and 122(2) match, authentication result indicates authentication should be performed. Otherwise, authentication result 336 indicates authentication should not be performed.

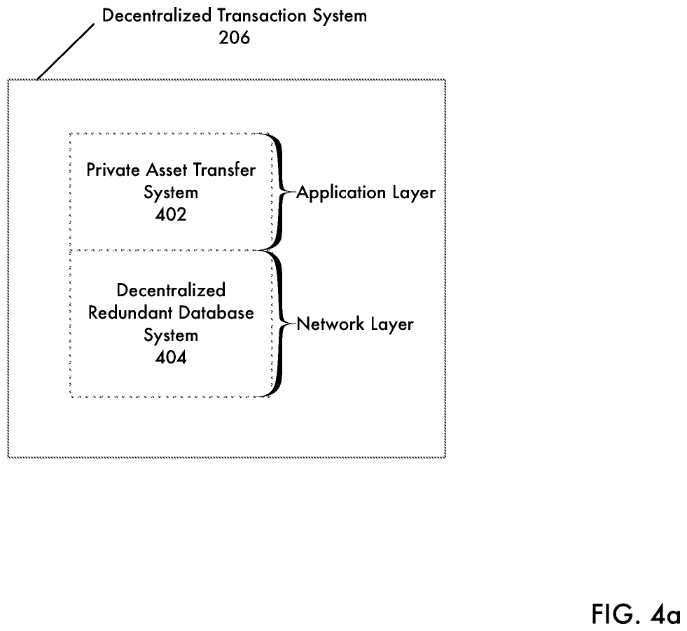

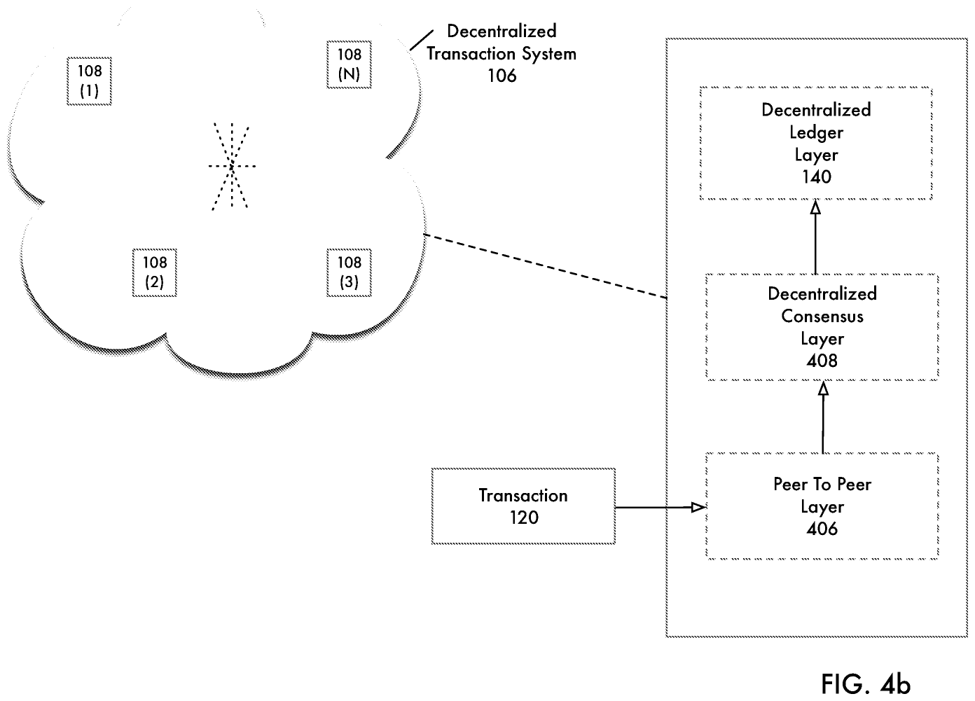

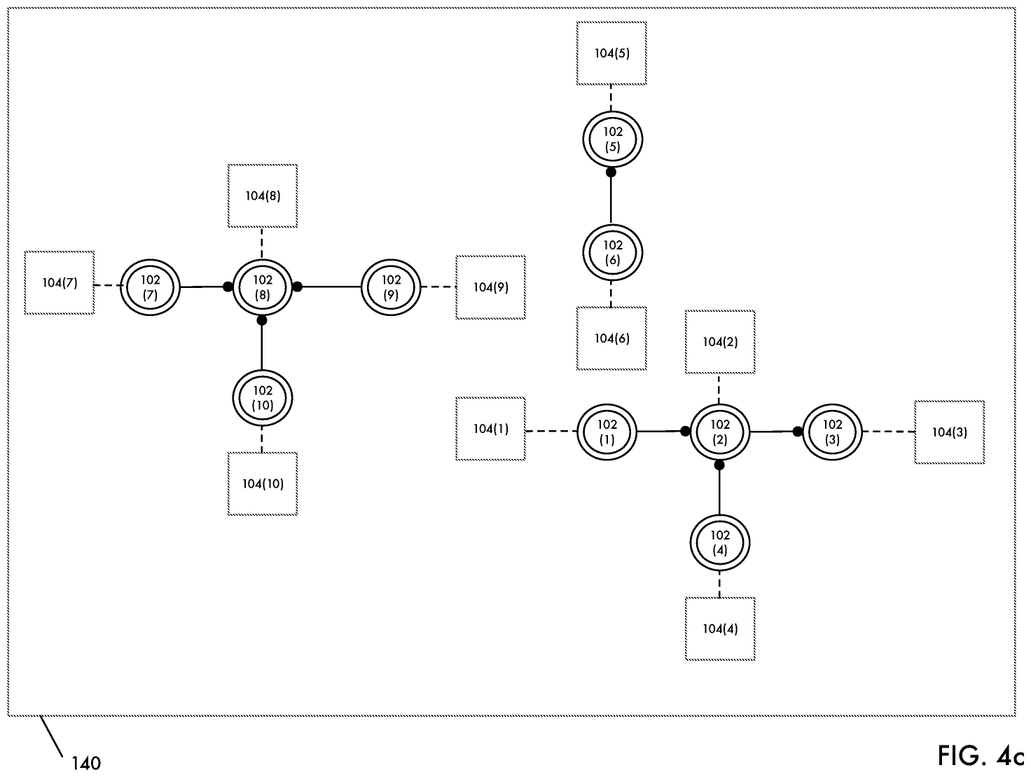

FIG. 4a is a high level block diagram of a decentralized transaction system according to an embodiment of the present disclosure. As shown in FIG. 4a, decentralized transaction system 106 further includes decentralized redundant database system 404 that operates at the network layer and multiple asset transfer system 402 that operates at the application layer. Thus, decentralized redundant database system 404 may power any type of transactions 120, not only the transfer of monetary assets. In this way, according to alternative embodiments of the present disclosure, the transfer of any type of multiple asset or right may be achieved using techniques disclosed herein.

FIG. 4b is a block diagram of a decentralized transaction system according to an embodiment of the present disclosure. The block diagram in FIG. 4b shows more detail than the high-level block diagram of FIG. 4a. Referring to FIG. 4a, decentralized transaction system 106 further includes peer-to-peer layer 406, decentralized consensus layer 408 and decentralized ledger layer 140. Decentralized ledger layer 140 pertains to the element previously referred to as decentralized ledger 140 and will be used interchangeably herein. As previously discussed, decentralized transaction system 106 may further include a number of servers 108(1) that communicate over peer-to-peer layer 406. As will be appreciated, peer-to-peer layer 406 allows for the exchange of information between any number of servers 108(1)-108(N) without the need for a centralized server. Thus, each server 108(1)-108(N) operating over peer-to-peer layer 406 operates as a file server as well as a client. Each server 108(1)-108(N) runs a server process, which facilitates any client communicating with that respective server to initiate transactions 120 (such as the sending and receiving of assets) with respect to decentralized transaction system 106.

In addition, such server process executed on each respective server 108(1)-108(N) participates in a consensus process as described in more detail below.

FIG. 4c depicts an example of a ledger in graphical form according to an embodiment of the present disclosure. FIG. 4c depicts an example state of decentralized ledger 140. It will be understood the format for representing transactions 120 in decentralized ledger 140 may assume a multitude of representations. Thus, FIG. 4c simply shows one example state of a decentralized ledger 140. Referring now to FIG. 4c, entities 102(1)-102(10) are respectively owned by agents 104(1)-104(10). This ownership is established by virtue of each respective agent 104 possessing a secret key/random seed 302 from which a respective address 122 and private/public keys 306/308 have been associated with the corresponding entity 102. Thus, for example, agent 104(1) utilized a secret key to generate an address that has been associated with entity 102(1), for example, by performing an address setting transaction 120.

FIG. 4c also shows that entities 102(1), 102(3) and 102(4) have established an account 116 with entity 102(2). In particular, this means that an indebtedness exists between entity 102(2) and entities 102(1), 102(3) and 102(4). Similarly, entity 102(6) holds an account 116 with entity 102(5) as do entities 102(7), 102(9) and 102(10) with respect to entity 102(8).

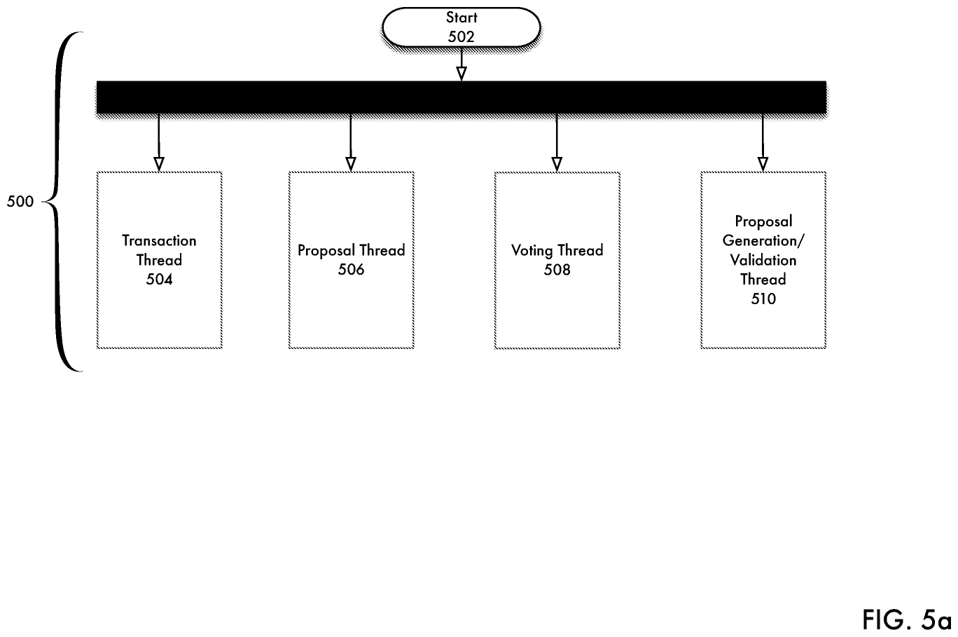

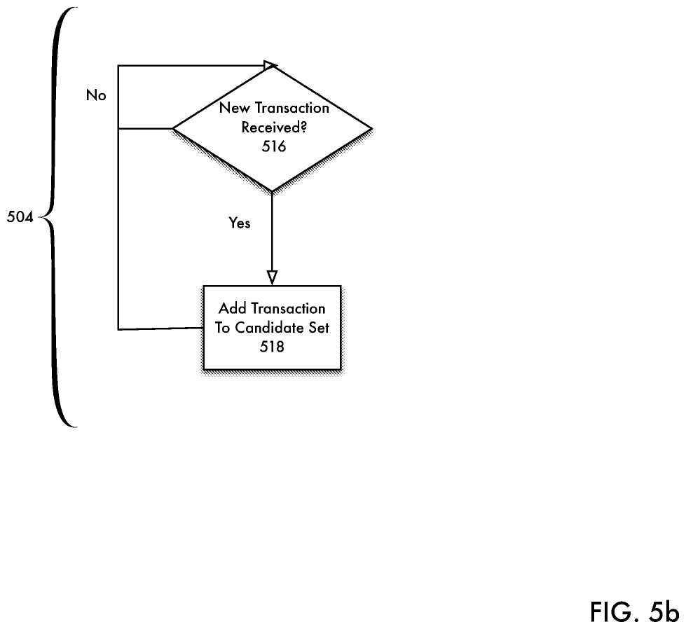

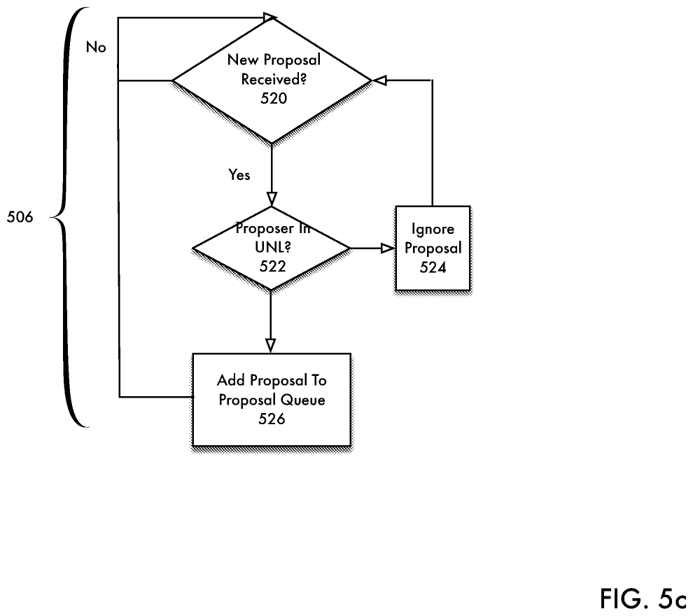

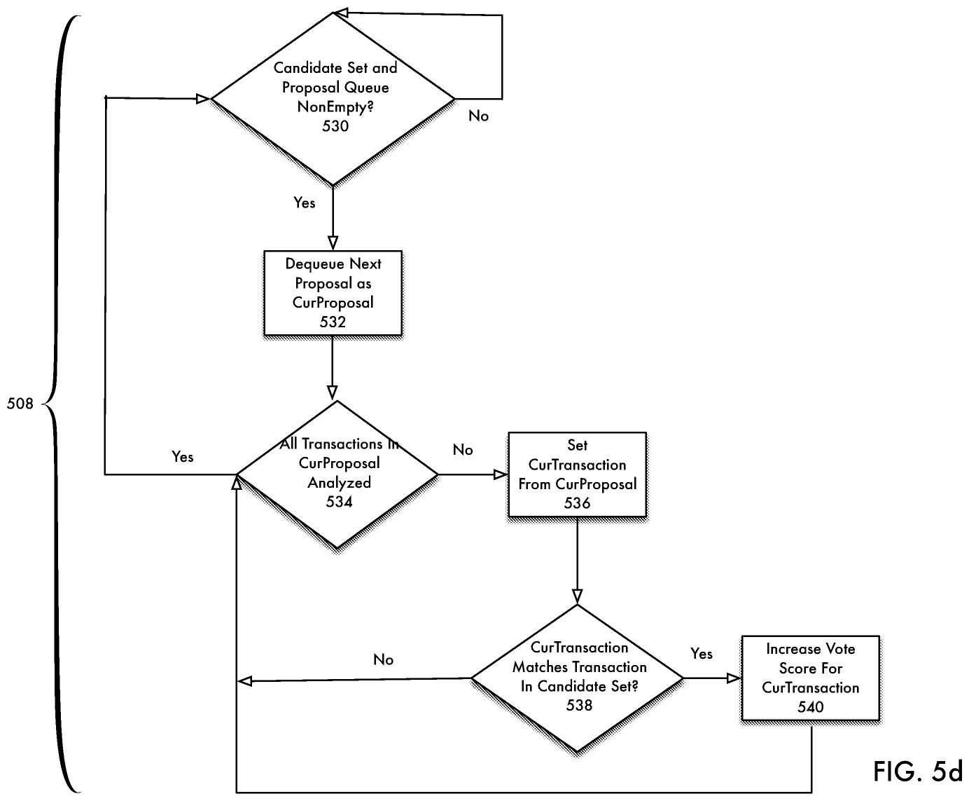

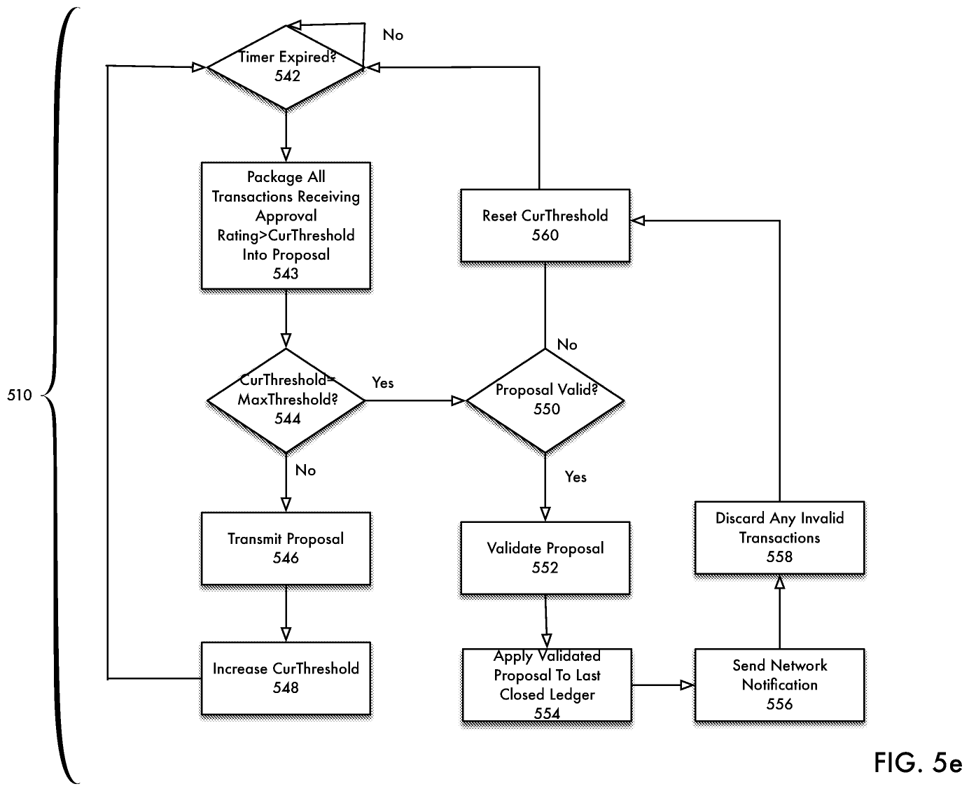

FIG. 5a is a high level flowchart of a consensus process according to an embodiment of the present disclosure. The consensus process 500 shown in FIG. 5a may be performed identically on each of a plurality of servers 108(1)-108(N) communicating over a peer-to-peer network. The collective behavior of all servers 108(1)-108(N) in carrying out the consensus process 500 is referred to herein as a consensus protocol. The goal of consensus for each server 108(1)-108(N) to apply the same set of transactions 120 to the ledger. Referring to FIG. 5a, consensus process 500 may further include transaction thread 504, proposal thread 506, voting thread 508 and proposal generation/validation thread 510. Transaction thread 504 receives transactions 120 from other servers 108(1)-108(N) communicating over peer-to-peer layer 406 and places those transactions 120 in a candidate set. A candidate set is a pool of transactions 120 waiting to be added to the ledger and may be stored in a queue or other suitable data structure. Simultaneously, proposal thread 506 receives proposals from other servers 108(1)-108(N) communicating over peer-to-peer layer and places those proposals in a queue. A proposal includes a proposed set of transactions 120 to be included in the current ledger such that each transaction 120 in a proposal has received a number of votes for inclusion in the ledger that exceeds a pre-determined threshold. Voting thread 508 performs voting by comparing transactions 120 stored in the candidate set with transactions 120 retrieved from stored proposals.

FIG. 5b is a flowchart depicting an operation of a transaction thread according to an embodiment of the present disclosure. As shown in FIG. 5b, transaction thread 504 may operate by determining whether a new transaction 120 has been received in 516. If no new transaction 120 has been received (‘No’ branch of 516), flow continues with 516 and the thread continues to wait for new transactions 120. Otherwise (‘Yes’ branch of 516) flow continues with 518 and the transaction 120 is placed in a candidate set, which may include a queue or other suitable data structure.

FIG. 5c is a flowchart depicting an operation of a proposal thread according to an embodiment of the present disclosure. Proposal thread 506 receives proposals from other servers (e.g., 108(1)-108(N)). According to an embodiment of the present disclosure, each server performing a consensus process 500 may store a unique node list (“UNL”). The UNL is a list of trusted external servers 108. Each server 108 has its own respective UNL. Referring now to FIG. 5c, in 520, it is determined whether a new proposal has been received. If not (‘No’ branch of 520), flow continues with 520 and the server 108 continues to wait for new proposals. If so (‘Yes’ branch of 520), flow continues with 522 where it is determined whether the proposal (the server 108 generating the proposal) is included in the UNL. If not (‘No’ Branch of 522), flow continues with 524 and the proposal is ignored. Flow then continues with 520 whereby the server 108 waits for new proposals. If the proposer is in the UNL (‘Yes’ branch of 522), flow continues with 526 whereby the received proposal is added to a queue of proposals for consideration by voting thread.

FIG. 5d is a flowchart depicting an operation of a voting thread according to an embodiment of the present disclosure. Transactions 120 in received proposals are compared with transactions 120 in the candidate set. When a transaction 120 in a proposal matches a transaction 120 in the candidate set, that transaction 120 receives one vote. Referring now to FIG. 5d, in 530 it is determined whether both the candidate set and the proposal queue are non-empty. If not (‘No’ branch of 530), flow continues with 530 and the test is performed again. If so (‘Yes’ branch of 530), flow continues with 532 and the next proposal is dequeued from the proposal queue and set to a variable CurProposal. In 534, it is determined whether all transactions 120 in the proposal identified by CurProposal have been analyzed. If so (‘Yes’ branch of 534), flow continues with 530. If not (‘No’ branch of 534), flow continues with 536 and the next transaction 120 in CurProposal is set to a variable called CurTransaction. In 538, it is determined whether the transaction 120 identified by CurTransaction matches a transaction 120 in the candidate set. If not (‘No’ branch of 538), flow continues with 534 and the next transaction 120 is analyzed. If so (‘Yes’ branch of 538), flow continues with 540 and the vote for the transaction 120 identified by CurTransaction is incremented. According to an embodiment of the present disclosure, each transaction 120 may include a data field for tracking votes. According to alternative embodiments, votes for transactions 120 may be stored in a separate data structure.

FIG. 5e is a flowchart depicting an operation of a proposal generation/validation thread according to an embodiment of the present disclosure. The process shown in FIG. 5e may be performed by proposal generation/validation thread 510. As previously described, transactions 120 and transmitted between servers 108(1)-108(N) and are packaged intro proposals, which are also transmitted between servers 108(1)-108(N). Each time a proposal in the candidate set of a particular server 108 is considered for inclusion into the next ledger, it may undergo a voting round in which it is compared with transactions 120 in received proposals. According to an embodiment of the present disclosure, each transaction 120 may be associated with an approval rating, which indicates a percentage of votes for that transaction's 120 inclusion in the next ledger out of the total number of voting entities that cast a vote with respect to that transaction 120. For example, if a transaction 120 was considered for inclusion in a proposal 10 times and received 4 votes, the approval rating for the proposal would be 40%.

According to an embodiment of the present disclosure, the determination of whether a transaction 120 should be included in a proposal is based upon whether that transaction 120 has an approval rating exceeding a predetermined threshold. According to an embodiment of the present disclosure, the threshold may be a dynamic variable that changes over time and is referred to herein as CurThreshold. In particular, according to an embodiment of the present disclosure, a parameter referred to herein as MaxThreshold may be defined. MaxThreshold indicates a required approval rating that must be established for all transactions 120 in a proposal for that proposal to be used to update the current ledger in order to generate a new last closed ledger.

Referring now to FIG. 5e, in 542 it is determined whether a timer has expired. If not (‘No’ branch of 542), flow continues with 542 and the timer is checked again. If so (‘Yes’ branch of 542), flow continues with 543 whereby all transactions 120 receiving an approval rating exceeding CurThreshold are packaged into a new proposal. It is assumed for purposes of this example that CurThreshold was initialized at startup of proposal generation/validation thread 510. In 544, it is determined whether CurThreshold=MaxThreshold. If not (‘No’ branch of 546), flow continues with 546 and the generated proposal is transmitted to the network (peer-to-peer layer 406). In 548, CurThreshold is increased by some predetermined increment. Flow then continues with 542 and the process is repeated again.

If CurThreshold=MaxThreshold as determined in 544 (‘Yes’ branch of 544), flow continues with 550 where it is determined whether the current proposal is valid. According to an embodiment of the present disclosure, the validity of a proposal is determined based upon whether all transactions 120 in the proposal have an approval rating exceeding MaxThreshold. If all transactions 120 in the proposal do not exceed MaxThreshold (‘No’ branch of 550), flow continues with 560 and the CurThreshold parameter is reset to its lowest value. Flow then continues with 542.

If all transactions 120 have an approval rating equal to or exceeding MaxThreshold, in 552, the proposal is validated, meaning that all transactions 120 in the proposal will be utilized to update the current ledger to generate a last closed ledger. Flow then continues with 554 wherein the validated proposal is applied to the last closed ledger. In 556, a network notification is generated and transmitted indicating a new last closed ledger has been generated. In 558, any invalid transactions 120 in the candidate set are discarded. Flow then continues with 560 whereby the CurThreshold parameter is reset.

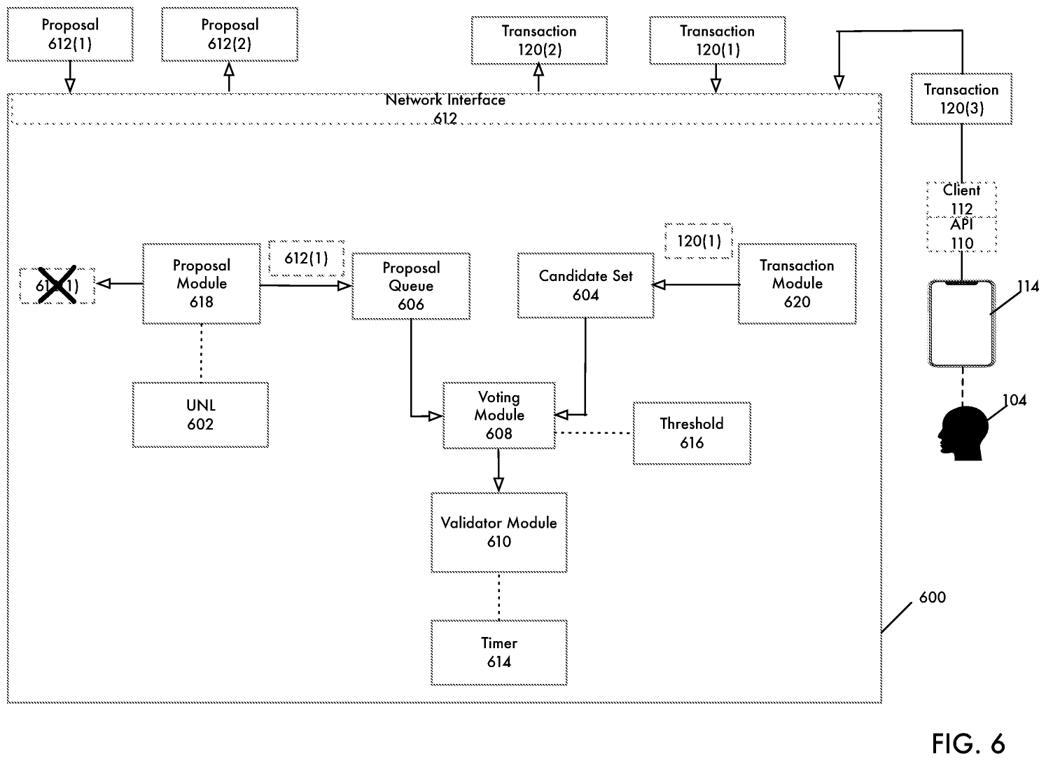

FIG. 6 is a block diagram of a consensus system according to an embodiment of the present disclosure. Consensus system 600 may run on each of a plurality of servers (e.g., 108(1)-108(N)), which may interoperate via peer-to-peer layer 406. Servers 108(1)-108(N) may each run consensus process 500 as described above respect to FIGS. 5a-5e. Consensus system may include transaction module 620 for handling incoming transactions 120, proposal module 618 for handling incoming proposals 612, voting module 608 for performing voting on transactions 120, validator module 610 for performing validation of proposals 612 for updating the current decentralized ledger 140. Consensus system 600 may further include candidate set 604 for storing incoming transactions 120 and proposal queue 606 for storing incoming proposals. Consensus system 600 may further include UNL 602 for storing a list of trusted servers 108, threshold module for storing a current approval threshold value and timer 614.

The operation of consensus system 600 will now be described. As previously noted, the collective operation of a distributed transaction system 106 allows for the initiation and consummation of transactions 120 in a decentralized manner. In order to facilitate trust in the validity and authenticity of transactions 120 initiated by agents (e.g., 104) according to an embodiment of the present disclosure, a decentralized consensus process may be utilized to validate and authenticate transactions 120, which may then be reflected in decentralized ledger 140. Thus, as shown in FIG. 6, agent 104 may utilize computing device 114 to generate a candidate transaction 120(3) utilizing API 110 and client 112 running on computing device 114. For example, transaction 120(3) may relate to the rotation of an address 122 with respect to an entity 102 in order to transfer multiple assets associated with entity 102 to an agent 104 providing a new address 122.

In this instance, for example, it is essential to insure that the transaction 120 is valid, i.e., there is no reason that the agent 104 may be attempting to perform a malicious or fraudulent transaction 120. For example, agent 104 may attempt to rotate a key twice with respect to the same entity 102, which is invalid. This type of malicious behavior should be prevented by the collective operation of the consensus process 600 carried out in a distributed manner via servers 108(1)-108(N). Further, the consensus process 600 as carried out in a decentralized environment should also detect unauthenticated transactions 120 (e.g., attempts by an agent 104 to perform transactions 120 with respect to entities 102 that they are not associated with (do not own)).

Although FIG. 6 shows a single consensus system 600, it will be understood that each server 108(1)-108(N) may run an identical consensus system 600. Each of a plurality of agents 104 attempting to initiate respective transactions 120 may use respective computing devices 114 running client 112 and API 110 in order to generate transactions 120, which are transmitted to one of the servers 108(1)-108(N). Transaction module 620 operates to received transactions 120 (e.g., 120(1)) either directly from a client 112 or from other servers 108(1)-108(N) and store them in candidate set 604, which may include a queue or other suitable data structure. In particular, according to an embodiment of the present disclosure, all servers (e.g., 108(1)-108(N)) running a respective consensus process 600 transmit received transactions 120 provided by clients to all other servers 108(1)-108(N), which are received as incoming transactions 120(1) and are also stored in candidate set 604. In effect, candidate set 604 stores transactions 120 generated by clients 112 or transmitted from other servers 108(1)-108(N) that are candidates for inclusion in an updated ledger.

According to an embodiment of the present disclosure, consensus system 600 operates to package transactions 120 meeting a threshold level of approval into a group referred to as a proposal 612 that includes a potential set of transactions 120 to be applied to the current ledger. These proposals are also transmitted amongst servers 108(1)-108(N) running consensus system 600 where they are received (612(1)) by proposal module 618, which executes proposal thread 506. Proposal module 618 then compares the server identity of the transmitting proposal 612 against UNL 602. If the transmitting server 108 is not in UNL 602, the proposal 612 is discarded. If, on the other hand, the received proposal is stored in proposal queue 606.

Voting module 608 operates simultaneously to execute voting thread 508, which performs voting with respect to transactions 120 in candidate set 604 by comparing the identity of those transactions 120 in proposals 612 in proposal queue 606.

Validator module 610 executes proposal generation/validation thread 510, which upon expiration of a timer attempts to generate a new proposal based upon threshold 610 for transmission to other servers 108(1)-108(N) or if threshold 610 is at its maximum value, attempts to generate a valid proposal for updating the current decentralized ledger 140.

It will be understood that peer-to-peer layer 406 may operate over any network any type of public or private network including the Internet or LAN.

As will be further appreciated, computing device 114, includes and/or otherwise has access to one or more non-transitory computer-readable media or storage devices having encoded thereon one or more computer-executable instructions or software for implementing techniques as variously described in this disclosure. The storage devices may include any number of durable storage devices (e.g., any electronic, optical, and/or magnetic storage device, including RAM, ROM, Flash, USB drive, on-board CPU cache, hard-drive, server storage, magnetic tape, CD-ROM, or other physical computer readable storage media, for storing data and computer-readable instructions and/or software that implement various embodiments provided herein. Any combination of memories can be used, and the various storage components may be located in a single computing device 114 or distributed across multiple computing devices 114. In addition, and as previously explained, the one or more storage devices may be provided separately or remotely from the one or more computing devices 114. Numerous configurations are possible.

In some example embodiments of the present disclosure, the various functional modules described herein and specifically training and/or testing of network 340, may be implemented in software, such as a set of instructions (e.g., HTML, XML, C, C++, object-oriented C, JavaScript, Java, BASIC, etc.) encoded on any non-transitory computer readable medium or computer program product (e.g., hard drive, server 108, disc, or other suitable non-transitory memory or set of memories), that when executed by one or more processors, cause the various creator recommendation methodologies provided herein to be carried out.

In still other embodiments, the techniques provided herein are implemented using software-based engines. In such embodiments, an engine is a functional unit including one or more processors programmed or otherwise configured with instructions encoding a creator recommendation process as variously provided herein. In this way, a software-based engine is a functional circuit.

In still other embodiments, the techniques provided herein are implemented with hardware circuits, such as gate level logic (FPGA) or a purpose-built semiconductor (e.g., application specific integrated circuit, or ASIC). Still other embodiments are implemented with a microcontroller having a processor, a number of input/output ports for receiving and outputting data, and a number of embedded routines by the processor for carrying out the functionality provided herein. In a more general sense, any suitable combination of hardware, software, and firmware can be used, as will be apparent. As used herein, a circuit is one or more physical components and is functional to carry out a task. For instance, a circuit may be one or more processors programmed or otherwise configured with a software module, or a logic-based hardware circuit that provides a set of outputs in response to a certain set of input stimuli. Numerous configurations will be apparent.

The foregoing description of example embodiments of the disclosure has been presented for the purposes of illustration and description. It is not intended to be exhaustive or to limit the disclosure to the precise forms disclosed. Many modifications and variations are possible in light of this disclosure. It is intended that the scope of the disclosure be limited not by this detailed description, but rather by the claims appended hereto.

What is claimed is:

1. A method for performing a transfer of multiple assets between a first agent and a second agent comprising:
upon receiving a first transaction request, associating a first entity with a first public key identifier, wherein said first public key identifier is associated with said first agent and allows said first agent to authenticate transactions with respect to said first entity;
upon receiving a second transaction request, establishing a first account for said first entity with a second entity wherein said account represents an owing of digital assets to said first entity by said second entity;
upon receiving a third transaction request, establishing a second account for said first entity with a third entity wherein said account represents an owing of digital assets to said first entity by said third entity; and,
upon receiving a fourth transaction request, associating said first entity with a second public key identifier associated with said second agent, wherein said second public key identifier allows said second agent to authenticate transactions with respect to said first entity and said first and second accounts.

2. The method according to claim 1, wherein said first and second public key identifiers are generated from a respective first secret key and a second secret key.

3. The method according to claim 2, wherein a respective first public key/private and second public key/private key are generated from said first and second secret keys.

4. The method according to claim 1, wherein each transaction further comprises a transaction identifier, a transaction signature and a public key associated with an agent generating said transaction.

5. The method according to claim 1, wherein said first, second, third and fourth transaction are performed over a decentralized transaction system further comprising a peer-to-peer layer, a decentralized ledger layer and a decentralized consensus layer.

6. The method according to claim 5, wherein said decentralized consensus system, upon performing a verification of said first, second, third and fourth transaction updates said decentralized ledger to include said first, second and third and fourth transactions.

7. The method according to claim 6, wherein said decentralized consensus system includes a transaction in a decentralized ledger if said transaction achieves an approval rating greater than a predetermined threshold.

8. A system for performing a transfer of multiple assets between a first agent and a second agent comprising:
a peer-to-peer layer;
a decentralized ledger layer; and,
a decentralized consensus layer, wherein said decentralized consensus layer operates to:
upon receiving and verifying a first transaction request, associates a first entity with a first public key identifier, wherein said first public key identifier is associated with a first agent and allows said first agent to authenticate transactions with respect to said first entity;
upon receiving and verifying a second transaction request, establishes a first account for said first entity with a second entity wherein said account represents an owing of digital assets to said first entity by said second entity;
upon receiving and verifying a third transaction request, establishes a second account for said first entity with a third entity wherein said account represents an owing of digital assets to said first entity by said third entity; and,
upon receiving and verifying a fourth transaction request, associates said first entity with a second public key identifier associated with said second agent, wherein said second public key identifier allows said second agent to authenticate transactions with respect to said first entity and said first and second accounts.

9. The system according to claim 8, wherein said first and second public key identifiers are generated from a respective first secret key and a second secret key.

10. The system according to claim 9, wherein a respective first public key/private and second public key/private key are generated from first and second secret keys.

11. The system according to claim 8, wherein each transaction further comprises a transaction identifier, a transaction signature and a public key associated with an agent generating said transaction.

12. The system according to claim 8, wherein said decentralized consensus layer, upon performing a verification of said first, second and third transaction updates said decentralized ledger to include said first, second and third transactions.

13. The method according to claim 8, wherein said decentralized consensus layer includes a transaction in a decentralized ledger if said transaction achieves an approval rating greater than a predetermined threshold.

14. A computer program product including one or more non-transitory machine readable mediums encoded with instructions that when executed by one or more processors cause a process to be carried out for performing a transfer of multiple assets between a first agent and a second agent comprising:
upon receiving a first transaction request, associating a first entity with a first public key identifier, wherein said first public key identifier is associated with said first agent and allows said first agent to authenticate transactions with respect to said first entity;
upon receiving a second transaction request, establishing a first account for said first entity with a second entity wherein said account represents an owing of digital assets to said first entity by said second entity;
upon receiving a third transaction request, establishing a second account for said first entity with a third entity wherein said account represents an owing of digital assets to said first entity by said third entity; and,
upon receiving a fourth transaction request, associating said first entity with a second public key identifier associated with said second agent, wherein said second public key identifier said second agent to authenticate transactions with respect to said first entity and said first and second accounts.

15. The computer program product according to claim 14, wherein said first and second public key identifiers are generated from a respective first secret key and a second secret key.

16. The computer program product according to claim 15, wherein a respective first public key/private and second public key/private key are generated from said first and second secret keys.

17. The computer program product according to claim 14, wherein each transaction further comprises a transaction identifier, a transaction signature and a public key associated with an agent generating said transaction.

18. The computer program product according to claim 14, wherein said first, second, third and fourth transaction are performed over a decentralized transaction system further comprising a peer-to-peer layer, a decentralized ledger layer and a decentralized consensus layer.

19. The computer program product according to claim 18, wherein said decentralized consensus system, upon performing a verification of said first, second, third and fourth transaction updates said decentralized ledger to include said first, second, third and fourth transactions.

20. The computer program product according to claim 19, wherein said decentralized consensus system includes a transaction in a decentralized ledger if said transaction achieves an approval rating greater than a predetermined threshold.
